(19) United States
(12) Patent Application Publication
(10) Pub. No.: US 2024/0163746 A1
(43) Pub. Date: May 16, 2024

(54) ENHANCEMENTS TO SELF-ORGANIZING NETWORK REPORTS FOR RADIO LINK FAILURE AFTER A DUAL ACTIVE PROTOCOL STACK FALLBACK

(71) Applicant: Telefonaktiebolaget LM Ericsson (publ), Stockholm (SE)

(72) Inventors: Marco BELLESCHI, Solna (SE); Pradeepa RAMACHANDRA, Linköping (SE); Ali PARICHEHREHTEROUJENI, Linköping (SE)

(21) Appl. No.: 18/281,063

(22) PCT Filed: Mar. 8, 2022
(86) PCT No.: PCT/IB2022/052057

§ 371 Date: Sep. 8, 2023

Related U.S. Application Data
(60) Provisional application No. 63/158,782, filed on Mar. 9, 2021.

(51) Int. Cl. H04W 36/00; H04W 36/18

(52) U.S. Cl. CPC H04W 36/0079; H04W 36/18

(57) ABSTRACT

A method performed by a wireless device for reporting failure information in a self-organizing network, SON, is provided. The method includes receiving, from a source cell (“cell”) while being connected to the cell, a handover command to attempt a handover to a target cell, one or more bearers associated with the handover to the target cell being configured with a dual active protocol stack, DAPS. The method includes experiencing a failure while attempting the handover. The method includes storing first failure information associated with the failure. The method includes performing a DAPS fallback to the cell based at least in part on experiencing the failure. The method includes experiencing a radio link failure, RLF, while being connected to the cell. The method includes storing second failure information associated with experiencing the RLF. The method includes transmitting the first or second failure information towards the SON.

### CROSS REFERENCE TO RELATED APPLICATIONS

This application is a 35 U.S.C. § 371 national stage application of PCT International Application No. PCT/IB2022/052057 filed on Mar. 8, 2022, which in turn claims domestic priority to U.S. Provisional Patent Application No. 63/158,782, filed on Mar. 9, 2021, the disclosures and content of which are incorporated by reference herein in their entirety.

### TECHNICAL FIELD

The present disclosure relates generally to communications, and more particularly to communication methods and related devices and nodes supporting wireless communications.

### BACKGROUND

Wireless Communication Systems in 3GPP

Consider the simplified wireless communication system illustrated in FIG. 1, with a UE 102, which communicates with one or multiple access nodes 103-104, which in turn is connected to a network node 106. The access nodes 103-104 are part of the radio access network 100.

For wireless communication systems pursuant to 3GPP Evolved Packet System, EPS (also referred to as Long Term Evolution, LTE, or 4G) standard specifications, such as specified in 3GPP TS 36.300 and related specifications, the access nodes 103-104 corresponds typically to an Evolved NodeB (eNB) and the network node 106 corresponds typically to either a Mobility Management Entity (MME) and/or a Serving Gateway (SGW). The eNB is part of the radio access network 100, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 100, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

Mobility in RRC_CONNECTED in LTE and NR

Mobility in RRC_CONNECTED state is also known as handover. The purpose of handover is to move the UE, due to e.g., mobility, from a source access node using a source radio connection (also known as source cell connection), to a target access node, using a target radio connection (also known as target cell connection). The source radio connection is associated with a source cell controlled by the source access node. The target radio connection is associated with a target cell controlled by the target access node. In other words, during a handover, the UE moves from the source cell to a target cell. Sometimes the source access node or the source cell is referred to as the “source”, and the target access node or the target cell is sometimes referred to as the “target”.

In some cases, the source access node and target access node are different nodes, such as different eNBs or gNBs. These cases are also referred to as inter-node handover, inter-eNB handover or inter-gNB handover. In other cases, the source access node and target access node are the same node, such as the same eNB and gNB. These cases are also referred to as intra-node handover, intra-eNB handover or intra-gNB handover and covers the case then source and target cells are controlled by the same access node. In yet other cases, handover is performed within the same cell (and thus also within the same access node controlling that cell)—these cases are also referred to as intra-cell handover.

It should therefore be understood that the source access node and target access node refer to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An RRC_CONNECTED UE in E-UTRAN or NG-RAN can be configured by the network to perform measurements of serving and neighbor cells and based on the measurement reports sent by the UE, the network may decide to perform a handover of the UE to a neighbor cell. The network then sends a Handover Command message to the UE (in LTE an RRConnectionReconfiguration message with a field called mobilityControlInfo and in NR an RRCReconfiguration message with a reconfigurationWithSync field).

These reconfigurations are actually prepared by the target access node upon a request from the source access node (over X2 or S1 interface in case of EUTRA-EPC or Xn or NG interface in case of NG-RAN-5GC) and takes into account the existing radio resource control (RRC) configuration and UE capabilities as provided in the request from the source access node and its own capabilities and resource situation in the intended target cell and target access node. The reconfiguration parameters provided by the target access node contains, for example, information needed by the UE to access the target access node, e.g., random access configuration, a new C-RNTI (cell radio network temporary identifier) assigned by the target access node and security parameters enabling the UE to calculate new security keys associated to the target access node so the UE can send a Handover Complete message (in LTE an RRConnectionReconfiguratioComplete message and in NR an RRCReconfigurationComplete message) on SRB1 (signalling radio bearer 1) encrypted and integrity protected based on new security keys upon accessing the target access node.

FIG. 2 summarizes the signalling flow between UE, source access node (also known as source gNB, source eNB or source cell) and target access node (also known as target gNB, target eNB or target cell) during a handover procedure, using LTE as example.

In FIG. 2, in step 1, the UE transmits a measurement report to the source access node during the interval data is being transmitted to the source access node, which in turn transmits the data to the serving gateway.

In step 2, the source access node determines that a handover should be performed. This may be based on the measurement report. In step 3, the source access node transmits a handover request to the target access node. In step 5, the source access node transmits an RRC connection reconfiguration message to the UE.

In step 6, the UE detaches from the source access node. In step 7, the source access node transmits a sequence number (SN) status transfer to the target access node. The source access node forwards any data received from UE to the target access node.

In step 8, the UE and target access node perform a random access procedure to initiate transmitting user data towards the SGW via the target access node. In step 9, the UE transmits an RRC connection reconfiguration complete message to the target access node. The UE then transmits user data to the target access node.

In step 10, the target access node transmits a path switch request to the MME. In step 11, the MME and SGW perform path switch related signaling to change the path from the source access node to the target access node. User data of the UE can then flow between the target access node and the SGW. The SGW transmits an end marker to the source access node, which in turn forwards the end marker to the target access node. In step 12, the MME transmits a path switch request acknowledgement to the target access node. In step 13, that target access node transmits a UE context release message to the source access node.

User Plane Handling During Handover

Depending on the required quality of service (QoS), either a seamless or a lossless handover is performed as appropriate for each user plane radio bearer, as explained in the following subsections.

Seamless Handover

Seamless handover is applied for user plane radio bearers mapped on radio link control (RLC) Unacknowledged Mode (UM). These types of data are typically reasonably tolerant of losses but less tolerant of delay (e.g., voice services). Seamless handover is therefore designed to minimize complexity and delay but may result in loss of some packet data convergence protocol (PDCP) service data units (SDUs).

At handover, for radio bearers to which seamless handover applies, the PDCP entities including the header compression contexts are reset, and the COUNT values are set to zero. As a new key is generated at handover, there is no security reason to maintain the COUNT values. PDCP SDUs in the UE for which the transmission has not yet started will be transmitted after handover to the target access node. In the source access node, PDCP SDUs that have not yet been transmitted can be forwarded via the X2/Xn interface to the target access node. PDCP SDUs for which the transmission has already started but that have not been successfully received will be lost. This minimizes the complexity because no context (e.g., configuration information) has to be transferred between the source access node and the target access node at handover.

Lossless Handover

Based on the SN that is added to PDCP Data PDUs it is possible to ensure in-sequence delivery during handover, and even provide a fully lossless handover functionality, performing retransmission of PDCP SDUs for which reception has not yet been acknowledged prior to the handover. This lossless handover function is used mainly for delay-tolerant services such as file downloads where the loss of one PDCP SDU can result in a drastic reduction in the data rate due to the reaction of the Transmission Control Protocol (TCP).

Lossless handover is applied for user plane radio bearers that are mapped on RLC Acknowledged Mode (AM). When RLC AM is used, PDCP SDUs that have been transmitted but not yet been acknowledged by the RLC layer are stored in a retransmission buffer in the PDCP layer.

In order to ensure lossless handover in the downlink (DL), the source access node forwards the DL PDCP SDUs stored in the retransmission buffer as well as fresh DL PDCP SDUs received from the gateway to the target access node for (re-)transmission. The source access node receives an indication from the core network gateway (SGW in LTE/EPC, UPF in LTE/5GC and NR) that indicates the last packet sent to the source access node (a so called “end marker” packet). The source access node also forwards this indication to the target access node 104 so that the target access node knows when it can start transmission of packets received directly from the gateway.

In order to ensure lossless handover in the uplink (UL), the UE retransmits the UL PDPC SDUs that are stored in the PDCP retransmission buffer in the target access node. The retransmission is triggered by the PDCP re-establishment that is performed upon reception of the handover command. The source access node, after decryption and decompression, will forward all PDCP SDUs received out of sequence to the target access node. Thus, the target access node 104 can reorder the PDCP SDUs received from the source access node 103 and the retransmitted PDCP SDUs received from the UE based on the PDCP SNs which are maintained during the handover, and deliver them to the gateway in the correct sequence.

An additional feature of lossless handover is so-called selective re-transmission. In some cases, it may happen that a PDCP SDU has been successfully received, but a corresponding RLC acknowledgement has not. In this case, after the handover, there may be unnecessary retransmissions initiated by the UE or the target access node based on the incorrect status received from the RLC layer. In order to avoid these unnecessary retransmissions a PDCP status report can be sent from the target access node to the UE and from the UE to the target access node. Whether to send a PDCP status report after handover is configured independently for each radio bearer and for each direction.

Rel-16 Dual Active Protocol Stacks (DAPS) handover

To address the shortcomings of Rel-14 MBB and achieve ˜0 ms interruption time, an enhanced version of Make-Before-Break (MBB), also known as Dual Active Protocol Stacks (DAPS) handover, is being specified for Rel-16 both for LTE and NR.

A DAPS Handover is defined as a handover procedure wherein the UE maintains the source gNB connection after reception of RRC message for handover (e.g., an RRCReconfiguration with a reconfigurationWithSync for the Master Cell Group—MCG) and until releasing the source cell after successful random access to the target gNB.

During DAPS handover it is assumed that the UE is capable of simultaneously transmitting and receiving from the source and target cells. In practice, this may require that the UE is equipped with dual transmit/receive (Tx/Rx) chains. The dual Tx/Rx chains potentially also allows DAPS handover to be supported in other handover scenarios such as inter-frequency handover.

An example of a DAPS inter-node handover is illustrated in FIG. 3 below for the case of LTE. In FIG. 3, steps 401 to 405 are analogous to steps 1-5 of FIG. 2 described above. Steps 409 to 412 are analogous to steps 10-13 of FIG. 2 described above

In step 405, upon receiving the “DAPS HO” indication in the Handover Command (set per bearer), e.g., an RRCReconfiguration with a reconfigurationWithSync for the Master Cell Group—MCG, the UE maintains the connection to the source cell associated to a source access node while establishing the connection to the target cell associated to a target access node (for the bearers configured with DAPS). That is, the UE can send and receive DL/UL user plane data via the source access node between step 405-408 without any interruption for the respective bearers. And after step 408, the UE has the target link available for UL/DL user plane data transmission similar to the regular HO procedure.

DAPS configuration for a given bearer is provided as part of the RadioBearerConfig, for each data radio bearer (DRB) to be configured with DAPS, as shown below, wherein the RadioBearerConfig IE is included in the RRCReconfiguration with a reconfigurationWithSync for the MCG:

| | |
|---|---|
| RadioBearerConfig ::= | SEQUENCE { |
| drb-ToAddModList | OPTIONAL, -- Cond HO-toNR |

...
}
. . .

| | |
|---|---|
| DRB-ToAddModList ::= | SEQUENCE (SIZE (1..maxDRB)) OF DRB-ToAddMod |
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| drb-Identity | DRB-Identity, | |
|---|---|---|
| reestablishPDCP | ENUMERATED{true} | OPTIONAL, -- Need N |
| recoverPDCP | ENUMERATED{true} | OPTIONAL, -- Need N |
| pdcp-Config | PDCP-Config | OPTIONAL, -- Cond PDCP |

```
  ...,
  [[
```

| | | |
|---|---|---|
| daps-Config-r16 | ENUMERATED{true} | OPTIONAL -- |

Need N
]]
}
. . .

In case of DAPS handover, the UE continues the downlink user data reception from the source gNB until releasing the source cell, i.e. daps-SourceRelease message transmitted by the target and continues the uplink user data transmission to the source gNB until successful random access procedure to the target gNB. In order to do that, the UE should keep performing radio link monitoring (RLM) with respect to the source cell for the whole duration of the handover, i.e. until RRCReconfigurationComplete containing HO completion information is transmitted. That implies, for example, that the UE should keep monitoring possible out-of-sync indications, whether the RLC retransmissions with the source exceed the threshold, etc., Obviously, in case RLF occurs in the source cell while performing DAPS, the UE releases the source connection, but it can continue the DAPS HO to the target.

Note that as previously discussed, the UE configured with DAPS HO can continue with UL transmissions towards the source cell until the handover is completed in the target, i.e. RRCReconfigurationComplete is transmitted to the target. For the DL instead, the source network node (e.g. a source gNodeB) can keep sending DL data until the source configuration release, conveyed in the daps-SourceRelease message transmitted by the target (after having received the RRCReconfigurationComplete) is received by the UE. Hence, even though UL data transmission to the source cell will not be prolonged beyond the handover completion, some UL transmissions to the source cell should be performed towards the source cell after the handover completion, such as HARQ ACK/NACK and other possible layer-1 control signaling.

The handover mechanism triggered by RRC requires the UE at least to reset the medium access control (MAC) entity and re-establish RLC, except for DAPS handover, where upon reception of the handover command, the UE:
Creates a MAC entity for target (i.e. a different/new MAC entity);
Establishes the RLC entity and an associated DTCH logical channel for target for each DRB configured with DAPS;
For the DRB configured with DAPS, reconfigures the PDCP entity with separate security and robust header compression (ROHC) functions for source and target and associates them with the RLC entities configured by source and target respectively;
Retains the rest of the source configurations until release of the source
   In RRC, UE actions are defined as follows:
   Reconfiguration with sync
   The UE shall perform the following actions to execute a reconfiguration with sync.
   . . .
   1> if no DAPS bearer is configured:
      2> stop timer T310 for the corresponding SpCell, if running;
   . . .
   1> If any DAPS bearer is configured:
      2> create a MAC entity for the target cell group with the same configuration as the
      MAC entity for the source cell group;
      2> for each DAPS bearer:
         3>establish an RLC entity or entities for the target cell group, with the same configurations as for the source cell group;
         3>establish the logical channel for the target cell group, with the same configurations as for the source cell group;
   . . .
      2> apply the value of the newUE-Identity as the C-RNTI in the target cell group;
      2> configure lower layers for the target SpCell in accordance with the received spCellConfigCommon;
      2> configure lower layers for the target SpCell in accordance with any additional fields, not covered in the previous, if included in the received reconfigurationWithSync.
   . . .
   RLC bearer addition/modification
   For each RLC-BearerConfig received in the rlc-BearerToAddModList IE the UE shall:
   1> if the UE's current configuration contains an RLC bearer with the received logicalChannelIdentity within the same cell group:
      2> if the RLC bearer is associated with a DAPS bearer:
         3> reconfigure the RLC entity or entities for the target cell group in accordance with the received rlc-Config;
         3> reconfigure the logical channel for the target cell group in accordance with the received mac-LogicalChannelConfig;
      2> else:
   . . .
   MAC entity configuration
   The UE shall:
   1> if SCG MAC is not part of the current UE configuration (i.e., SCG establishment):
      2> create an SCG MAC entity;
   1> if any DAPS bearer is configured:
      2> reconfigure the MAC main configuration for the target cell group in accordance with the received mac-CellGroupConfig excluding tag-ToReleaseList and tag-ToAddModList;
   . . .

In step 406, the source access node sends an SN status transfer message to the target access node, indicating UL PDCP receiver status and the SN of the first forwarded DL PDCP SDU. The uplink PDCP SN receiver status includes at least the PDCP SN of the first missing UL SDU and may include a bit map of the receive status of the out of sequence UL SDUs that the UE needs to retransmit in the target cell, if there are any such SDUs. The SN Status Transfer message also contains the Hyper Frame Number (HFN) of the first missing UL SDU as well as the HFN DL status for COUNT preservation in the target access node.

Once the connection setup with the target access node is successful, i.e. after sending the Handover Complete message in step 408, the UE maintains two data links, one to the source access node and one to the target access node (except in the UL where the UE only uses the target after successful random access). After step 408, the UE transmits the UL user plane data on the target access node similar to the regular HO procedure using the target access node security keys and compression context. Thus, there is no need for simultaneous UL user data transmission to both nodes which avoids UE power splitting between two nodes and also simplifies UE implementation. In the case of intra-frequency handover, transmitting UL user plane data to one node at a time also reduces UL interference which increases the chance of successful decoding at the network side.

The UE needs to maintain the security and compression context for both source access node and target access node until the source link is released. The UE can differentiate the security/compression context to be used for a PDCP PDU based on the cell which the PDU is transmitted on.

To avoid packet duplication, the UE may send a PDCP status report together with the Handover Complete message in step 408, indicating the last received PDCP SN. Based on the PDCP status report, the target access node can avoid sending duplicate PDCP packets (i.e. PDCP PDUs with identical sequence numbers) to the UE, i.e. PDCP packets which were already received by the UE in the source cell.

The release of the source cell in step 413 can e.g. be triggered by an explicit message from the target access node (not shown in the figure) or by some other event such as the expiry of a release timer.

As an alternative to source access node starting packet data forwarding after step 405 (i.e. after sending the Handover Command to the UE, also known as “early packet forwarding”), the target access node may indicate to the source access node when to start packet data forwarding. For instance, the packet data forwarding may start at a later stage when the link to the target cell has been established, e.g. after the UE has performed random access in the target cell or when the UE has sent the RRC Connection Reconfiguration Complete message to the target access node (also known as “late packet forwarding”). By starting the packet data forwarding in the source access node at a later stage, the number of duplicated PDCP SDUs received by the UE from the target cell will potentially be less and by that the DL latency will be somewhat reduced. However, starting the packet data forwarding at a later stage is also a trade-off between robustness and reduced latency if, e.g., the connection between the UE and the source access node is lost before the connection to the target access node is established. In such case there will be a short interruption in the DL data transfer to the UE.

FIG. 4 shows the protocol stack at the UE side at Dual Active Protocol Stack (DAPS) handover. Each user plane radio bearer has an associated PDCP entity which in turn has two associated RLC entities—one for the source cell and one for the target cell. The PDCP entity uses different security keys and ROHC contexts for the source and target cell while the SN allocation (for UL transmission) and re-ordering/duplication detection (for DL reception) is common.

Note that in case of NR, there is an additional protocol layer called SDAP (service data application protocol) on top of PDCP which is responsible for mapping QoS flows to bearers. This layer is not shown in FIG. 4 and shall not be discussed in detail herein.

DAPS Handover Failure

Timer based handover failure procedure is supported in NR (i.e., the UE starts timer T304 when receives the RRCReconfiguration with reconfiguration with sync, and stops the timer when successful, and upon expiry declares handover failure). The RRC connection re-establishment procedure is used for recovering from handover failure.

However, when DAPS HO fails, the UE has the possibility to fall back to source cell configuration, resumes the connection with source cell, and reports DAPS HO failure via the source without triggering RRC connection re-establishment if the source link has not been released. Such fallback to the source cell can only occur in case RLF with respect to the source cell has not been declared yet at the time the T304 timer expires. Once the UE has fell back to the source cell, the UE issues a failure information to indicate to the source cell that the UE failed the DAPS HO towards the target cell.

Otherwise, if RLF with respect to the source cell has already occurred at the time the DAPS handover to the target fails, i.e., timer T304 expires, the UE selects a third cell different from the source and the target for reestablishment.

Self-Organizing Networks (SON) in 3GPP

A Self-Organizing Network (SON) is an automation technology designed to make the planning, configuration, management, optimization, and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, the processes within the SON area are classified into Self-configuration process and Self-optimization process. Self-configuration process is the process where newly deployed nodes are configured by automatic installation procedures to get the necessary basic configuration for system operation.

This process works in pre-operational state. Pre-operational state is understood as the state from when the eNB is powered up and has backbone connectivity until the RF transmitter is switched on.

As illustrated in FIG. 5, functions handled in the pre-operational state like:
Basic Setup; and
Initial Radio Configuration.
   are covered by the Self Configuration process. Some of the basis setup functions are shown in A-1 to A-4 in FIG. 5. Some of the initial radio configuration is shown in B-1 to B-2 in FIG. 5.

Self-optimization process is defined as the process where UE and access node measurements and performance measurements are used to auto-tune the network.

This process works in the operational state. The operational state is understood as the state where the RF interface is additionally switched on.

As illustrated in FIG. 5, functions handled in the operation state like
Optimization/Adaptation
   are covered by the Self Optimization process. Some of the optimization/adaptation functions are shown in C-1 and C-2 in FIG. 5.

In LTE, support for Self-Configuration and Self-Optimization is specified, as described in 3GPP TS 36.300 section 22.2, including features such as Dynamic configuration, Automatic Neighbor Relation (ANR), Mobility load balancing, Mobility Robustness Optimization (MRO), RACH optimization and support for energy saving.

In NR, support for Self-Configuration and Self-Optimization is specified as well, starting with Self-Configuration features such as Dynamic configuration, Automatic Neighbor Relation (ANR) in Ra-15, as described in 3GPP TS 38.300 section 15. In NR Rel-16, more SON features are being specified for, including Self-Optimization features such as Mobility Robustness Optimization (MRO).

Mobility Robustness Optimization (MRO) in 3GPP

Seamless handovers are a key feature of 3GPP technologies. Successful handovers ensure that the UE moves around in the coverage area of different cells without causing too many interruptions in the data transmission. However, there will be scenarios when the network fails to handover the UE to the ‘correct’ neighbor cell in time and in such scenarios the UE will declare the radio link failure (RLF) or Handover Failure (HOF).

Upon HOF and RLF, the UE may take autonomous actions i.e. trying to select a cell and initiate reestablishment procedure so that we make sure the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell (random access procedure, RRC Reestablishment Request, RRC Reestablishment RRC Reestablishment Complete, RRC Reconfiguration and RRC

Reconfiguration Complete) and adds some latency, until the UE can exchange data with the network again.

According to the specifications (3GPP TS 36.331), the possible causes for the radio link failure could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the MAC entity

As RLF leads to reestablishment which degrades performance and user experience, it is in the interest of the network to understand the reasons for RLF and try to optimize mobility related parameters (e.g., trigger conditions of measurement reports) to avoid later RLFs. Before the standardization of MRO related report handling in the network, only the UE was aware of some information associated to how did the radio quality looked like at the time of RLF, what is the actual reason for declaring RLF etc. For the network to identify the reason for the RLF, the network needs more information, both from the UE and also from the neighboring base stations.

As part of the MRO solution in LTE, the RLF reporting procedure was introduced in the RRC specification in Rel-9 RAN2 work. That has impacted the RRC specifications (TS 36.331) in the sense that it was standardized that the UE would log relevant information at the moment of an RLF and later report to a target cell the UE succeeds to connect (e.g., after reestablishment). That has also impacted the inter-gNodeB interface, i.e., X2AP specifications (3GPP TS 36.423), as an eNodeB receiving an RLF report could forward to the eNodeB where the failure has been originated.

For the RLF report generated by the UE, its contents have been enhanced with more details in the subsequent releases. The measurements included in the measurement report based on the latest LTE RRC specification are:
1) Measurement quantities (RSRP, RSRQ) of the last serving cell (PCell).
2) Measurement quantities of the neighbor cells in different frequencies of different RATs (EUTRA, UTRA, GERAN, CDMA2000).
3) Measurement quantity (RSSI) associated to WLAN Aps.
4) Measurement quantity (RSSI) associated to Bluetooth beacons.
5) Location information, if available (including location coordinates and velocity)
6) Globally unique identity of the last serving cell, if available, otherwise the PCI and the carrier frequency of the last serving cell.
7) Tracking area code of the PCell.
8) Time elapsed since the last reception of the ‘Handover command’ message.
9) C-RNTI used in the previous serving cell.
10) Whether or not the UE was configured with a DRB having QCI value of 1.

After the RLF is declared, the RLF report is logged and include in the VarRLF-Report and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report (stored in a UE variable VarRLF-Report, as described above) in an UElnformationResponse message and send to the network.

Based on the RLF report from the UE and the knowledge about which cell did the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as too-early, too-late or handover to wrong cell classes. These handover failure classes are explained in brief below.
1) Whether the handover failure occurred due to the ‘too-late handover’ cases
   a. The original serving cell can classify a handover failure to be ‘too late handover’ when the original serving cell fails to send the handover command to the UE associated to a handover towards a particular target cell and if the UE reestablishes itself in this target cell post RLF.
   b. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.
2) Whether the handover failure occurred due to the ‘too-early handover’ cases
   a. The original serving cell can classify a handover failure to be ‘too early handover’ when the original serving cell is successful in sending the handover command to the UE associated to a handover however the UE fails to perform the random access towards this target cell.
   b. An example corrective action from the original serving cell could be to initiate the handover procedure towards this target cell a bit later by increasing the CIO (cell individual offset) towards the target cell that controls when the IE sends the event triggered measurement report that leads to taking the handover decision.
3) Whether the handover failure occurred due to the ‘handover-to-wrong-cell’ cases
   a. The original serving cell can classify a handover failure to be ‘handover-to-wrong-cell’ when the original serving cell intends to perform the handover for this UE towards a particular target cell but the UE declares the RLF and reestablishes itself in a third cell.
   b. A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

### SUMMARY

There currently exist certain challenge(s). In the current RLF framework, the scenario of RLF after fallback is not considered. In particular, as per current RLF framework, the UE would store in VarRLF-Report, the RLF information related to the hand off from a first cell to a second cell. Afterwards, when the RLF is experienced in the first cell after fallback, the UE would cancel (e.g., delete) any previous RLF report in VarRLF-Report and create a new RLF report which for example include information associated to the previous handover, e.g., the previous PCellID, the time of RLF from the latest handover etc. Since at this point, the UE has already cancelled the information related to the handover from the first cell to the second cell, the network would not have to possibility to determine 1) whether such RLF occurred just after the handover from a cell to the first cell, e.g., before the handover from the first cell to the second cell, in which case the network may categorize such handover as “too early HO” from the other cell to the first cell or 2) whether such RLF occurred after the failed handover from the first cell to the second cell, in which case the network may categorize it as “too late HO” from cell B.

Hence, such ambiguity would impede the network to determine whether it should be the handover configuration of the other cell that needs to be optimized (e.g., to avoid “too early” HO) or the handover configuration of the first cell (e.g., to avoid “to late” HO).

Accordingly, a method of including RLF information in the event of an occurrence of RLF after DAPS fallback is provided.

According to some embodiments, a method performed by a wireless device for reporting failure information in a self-organizing network (SON) is provided. The method includes receiving, from a source cell while being connected to the source cell, a handover command to attempt a handover from the source cell to a target cell, one or more bearers associated with the handover from the source cell to the target cell being configured with a dual active protocol stack, DAPS. The method includes experiencing a failure while attempting the handover from the source cell to the target cell. The method includes storing first failure information associated with the failure while attempting the handover from the source cell to the target cell. The method includes performing a DAPS fallback to the source cell based at least in part on experiencing the failure while attempting the handover from the source cell to the target cell. The method includes experiencing a radio link failure, RLF, while being connected to the source cell. The method includes transmitting the first failure information or the second failure information towards the SON.

Analogous wireless devices, computer programs, and computer program products are provided.

Certain embodiments may provide one or more of the following technical advantage(s). The various embodiments described in this disclosure allow a UE to reflect in the RLF-Report the scenario of “RLF after DAPS fallback”, and also allows the network to unambiguously distinguish within the same RLF-report which parameters/information are associated to the “RLF after DAPS fallback” case for the handover between a first cell and a second cell and which parameters are associated to the previous handover from another cell to the first cell.

According to other embodiments, a method performed by a base station in a self-organizing network (SON) is provided. The method includes receiving first failure information or second failure information from a wireless device. The method includes determining whether the wireless device experienced a radio link failure, RLF, after performing a dual active protocol stack, DAPS, fallback. The method includes optimizing a handover configuration including optimizing one or more handover parameters based at least in part on determining the wireless device experienced the RLF after performing the DAPS fallback.

Analogous base stations, computer programs, and computer program products are provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a simplified wireless communication system;

FIG. 2 is a signaling diagram illustrating signalling flow between a UE, a source access node and a target access node during a handover procedure;

FIG. 3 is a signaling diagram illustrating DAPS handover;

FIG. 4 is a block diagram illustrating an example of a dual active protocol stack (DAPS) on the UE side;

FIG. 5 is a block diagram illustrating self-configuration/self-optimization functionality;

FIG. 6 is a block diagram illustrating a scenario of RLF after DAPS fallback according to some embodiments;

FIG. 7 is a block diagram illustrating a scenario of RLF after DAPS fallback according to some other embodiments;

FIGS. 8-19 are flow charts illustrating operations of a user equipment according to some embodiments;

FIGS. 20-22 are flow charts illustrating operations of a network node according to some embodiments;

FIG. 23 is a block diagram of a wireless network in accordance with some embodiments;

FIG. 24 is a block diagram of a user equipment in accordance with some embodiments; and

FIG. 25 is a block diagram of a virtualization environment in accordance with some embodiments.

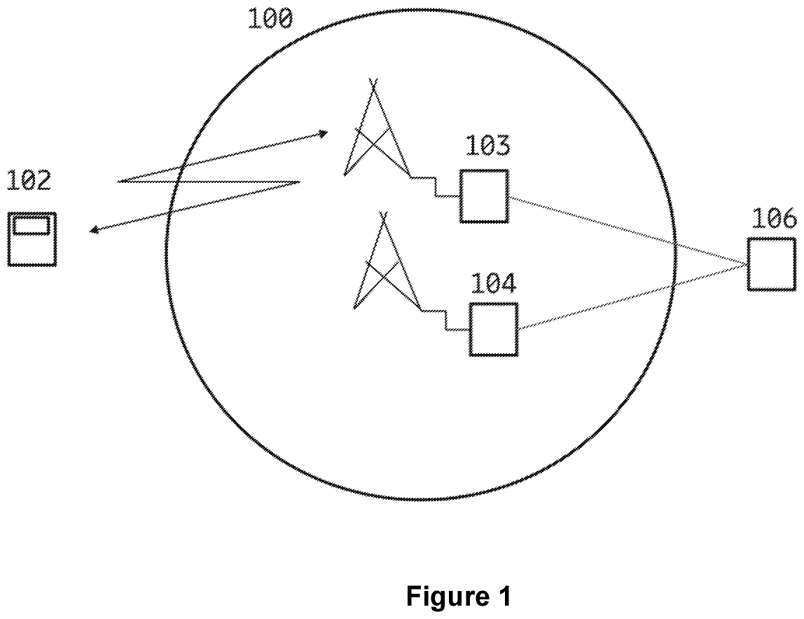

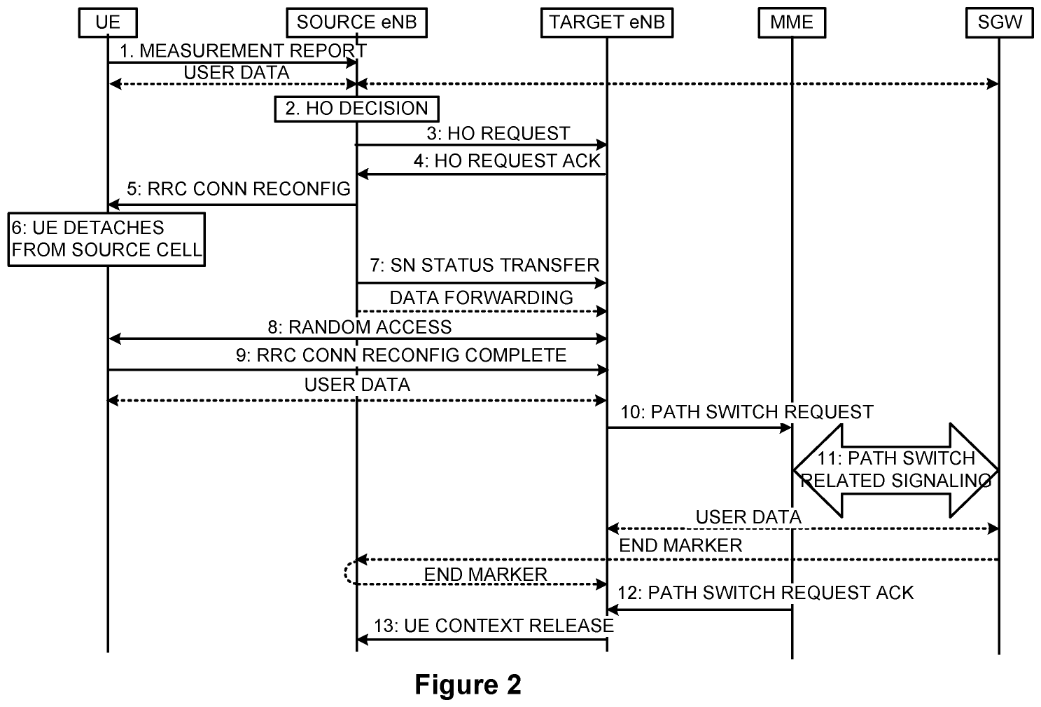

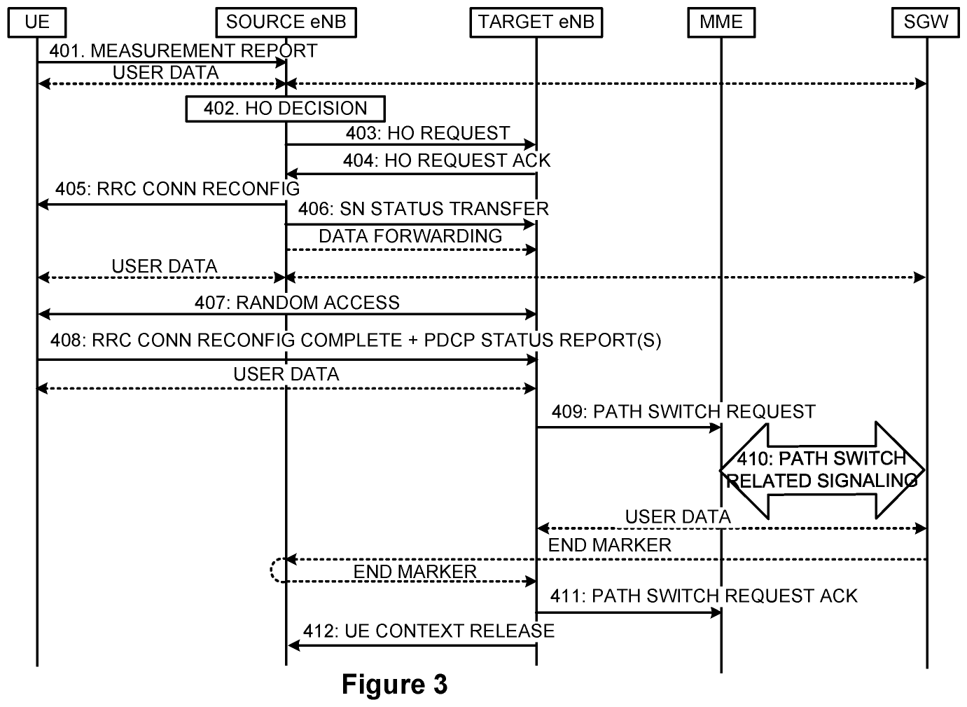

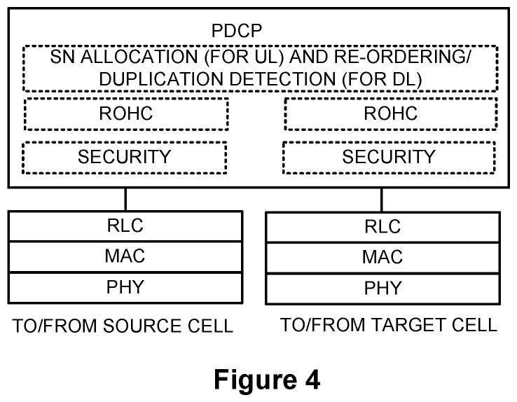

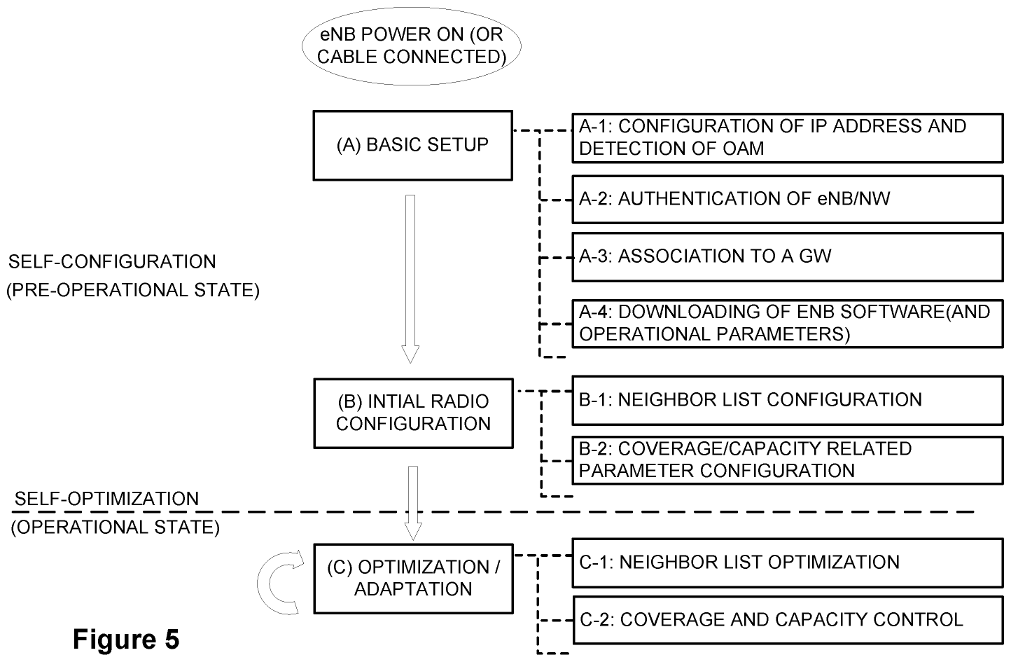

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

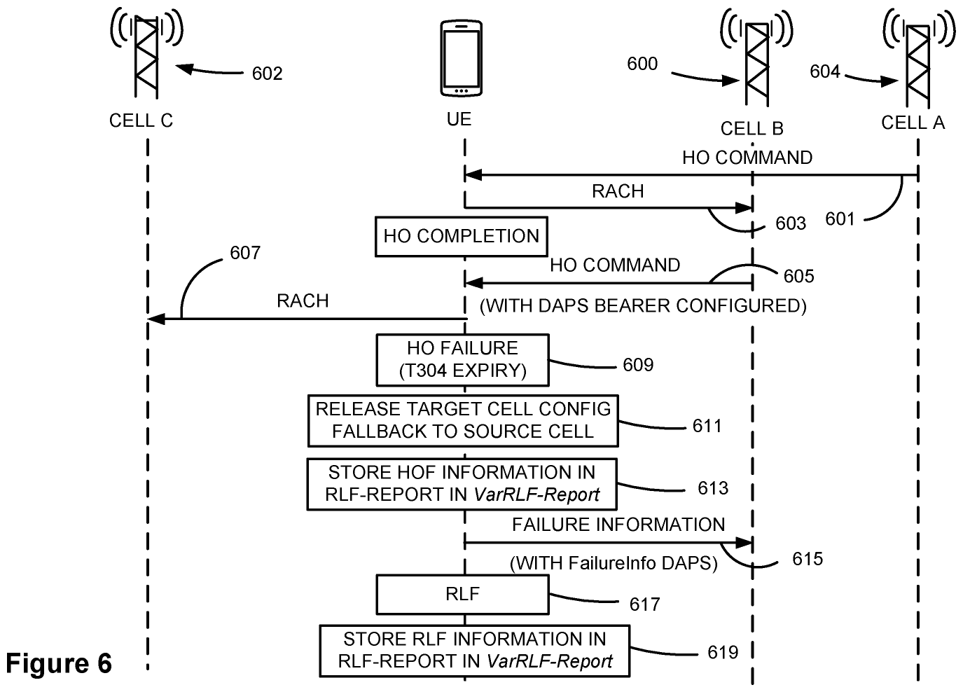

As previously indicated, RLF after fallback is not considered in the current RLF framework. RLF after fallback is illustrated in FIG. 6.

Turning to FIG. 6, the UE (e.g., UE 2400) receives an HO command from Cell A 604 in block 601, and the UE succeeds to perform handover to cell B 600 via a random access procedure in block 603. Then the source cell B 600 triggers a DAPS HO for the UE that is received by the UE in block 605. The UE triggers a random access procedure towards the target Cell C 602 in block 607, while keeping the MAC configuration with the source cell B 600 so that the UE can continue communicating with the source cell B 600. However, in this scenario, the UE does not complete the handover towards cell C 602 due to a handover failure in block 609, e.g., T304 timer expires, and as a result, the UE performs a DAPS fallback to the source cell B 600 in block 611. The UE stores the HO failure information in the VarRLF-Report in block 613 and transmits the failure information with the HO failure information to source Cell B 600 in block 615. After that, while still being in Cell B 600, the UE experiences an RLF in Cell B 600 in block 617, and the UE stores the RLF information in the VarRLF-Report container in step 619, which may be transmitted to the network and be used for SON purposes.

The problem is that as per the current RLF framework, the scenario of “RLF after fallback” as illustrated in FIG. 6, is not considered. In particular, as per current RLF framework, the UE would store in VarRLF-Report, the RLF information related to the HOF from cell B 600 to Cell C 602. Afterwards, when the RLF is experienced in the Cell B 600 after fallback, the UE would cancel (e.g., delete) any previous RLF report in the VarRLF-Report and create a new RLF report which, for example, includes information associated to the previous handover, e.g., the previous PCellID, the time of RLF from the latest handover etc. Since at this point, the UE has already cancelled the information related to the HO failure from Cell B 600 to Cell C 602, the network would not have to possibility to determine 1) whether such RLF occurred just after the handover from cell A 604 to cell B 600, e.g., before the HOF from cell B 600 to cell C 602, in which case the network may categorize such HO as “too early HO” from cell A 604 to cell B 600 or 2) whether such RLF occurred after the failed HO from cell B 600 to cell C 602, in which case the network may categorize it as “too late HO” from cell B 600.

Hence, such ambiguity would impede the network to determine whether it should be the handover configuration of the cell A that needs to be optimized (e.g., to avoid “too early” HO) or the handover configuration of the cell B (e.g., to avoid “to late” HO).

For example, after the RLF in the Cell B 600, the UE, as per current legacy specification, will include the timeConnFailure, e.g., the time elapsed since the last HO initialization until connection failure. In this case the last HO initialization occurred when the cell B 600 sent the HO command to the cell C 602. However, the current RLF-Report does not allow the network to determine whether such time represents the time elapsed between the RLF and the HO triggered from cell B 600 to cell C 602 (and that resulted in an HOF), or the time elapsed between the RLF and the HO triggered from cell A 604 to cell B 600 (that was successful).

The various embodiments proposed herein allow a UE to reflect in the RLF-Report the scenario of “RLF after DAPS fallback” illustrated in FIG. 6, and also allows the network to unambiguously distinguish within the same RLF-report which parameters/information are associated to the “RLF after DAPS fallback” case for the handover between Cell B and Cell C and which parameters are associated to the previous handover from Cell A to Cell B.

### Terminology

The term “cell A” refers to a first cell hosted by a distributed unit (DU) from which the UE executes the handover to a second cell said “cell B.”

The term “cell B” refers to a second cell hosted by a DU to which the UE executes the handover from the first cell and from which the UE executes the handover to a third cell said “cell C.”

The term “cell C” refers to a third cell hosted by a DU to which the UE executes the handover from the second cell, wherein the said handover execution results in a handover failure (HOF).

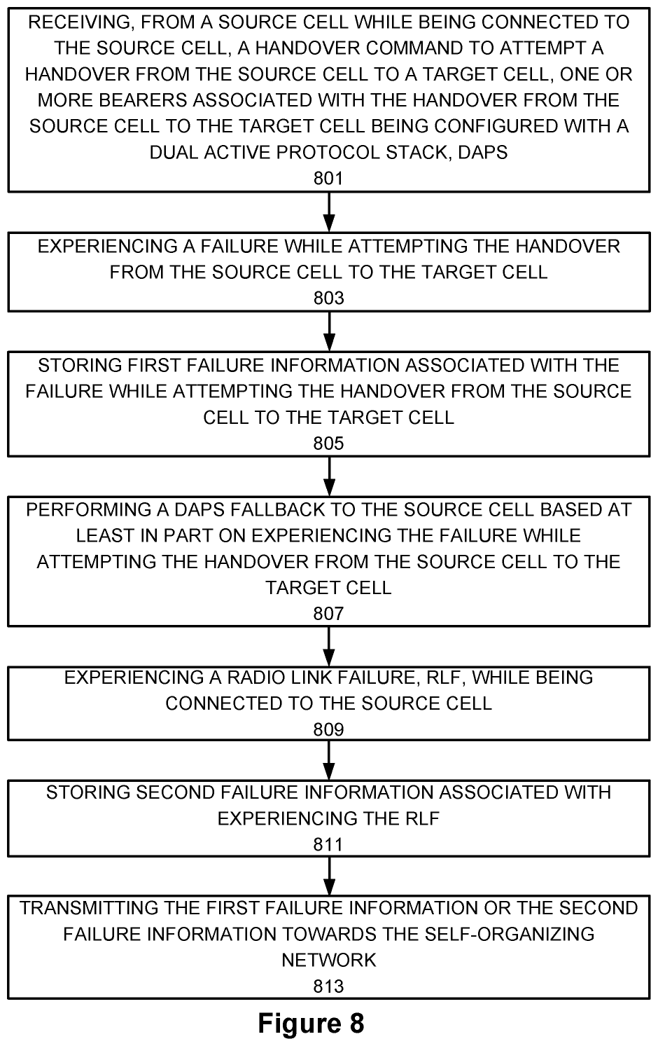

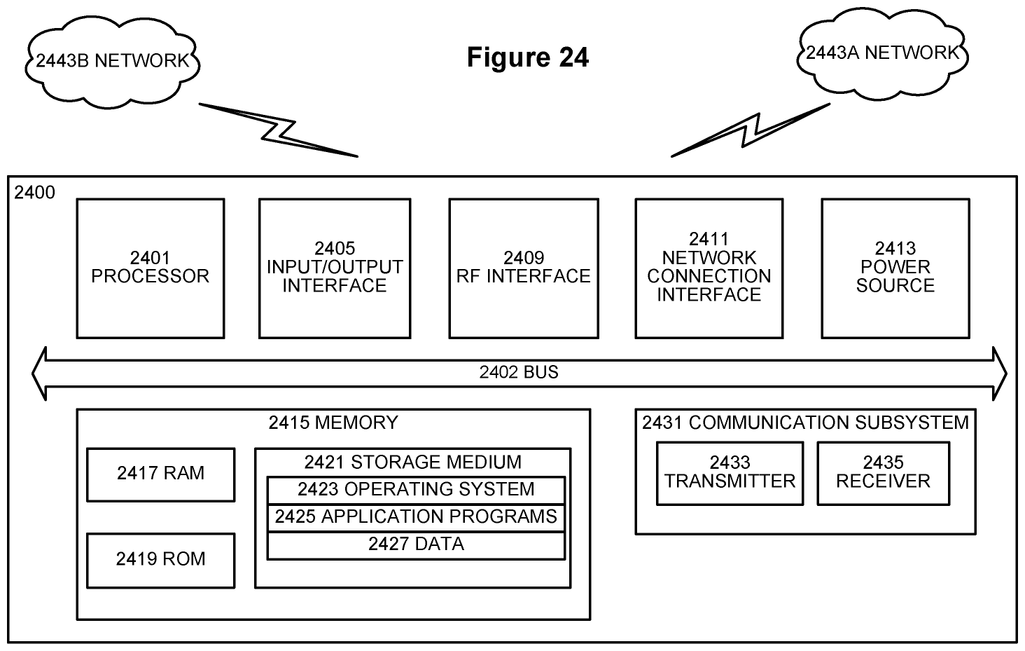

The UE in the various embodiments described herein will refer to the UE 2400 (implemented using the structure of the block diagram of FIG. 24 as described below) and will be discussed with reference to the flow charts of FIGS. 8-19 according to some embodiments of inventive concepts. For example, modules may be stored in memory 2415 of FIG. 24, and these modules may provide instructions so that when the instructions of a module are executed by respective communication device processing circuitry 2401, processing circuitry 2401 performs respective operations of the flow chart.

Returning to FIG. 6, in some aspects, the scenario depicted in FIG. 6 comprises the following actions executed by the UE 2400 in some embodiments:
1. Receiving a HO command from Cell A 604 to Cell B 600 in block 601.
2. Successfully completing the HO in Cell B 600 in block 603.
3. Receiving, while connected to Cell B 600, an RRCReconfiguration message including reconfigurationWithSync and with one or more bearers configured with DAPS for handover towards Cell C 602 in block 605.
4. Executing the HO towards Cell C 602 in block 607.
5. Experiencing an HO failure while executing the HO towards Cell C 602 in block 609, e.g., T304 expiry.
6. Performing a fallback to Cell B 600 in block 611, e.g., transmitting a FailureInformation message indicating DAPS failure to the cell B 600.
7. Storing a first RLF-Report associated to the HO failure experienced at step 5 in block 613
8. Experiencing an RLF in cell B 600 in block 716
9. Optionally clear the information included in RLF-Report variable
10. Storing a second RLF-Report associated to the RLF experienced at step 8 (i.e., block 617) in block 619.

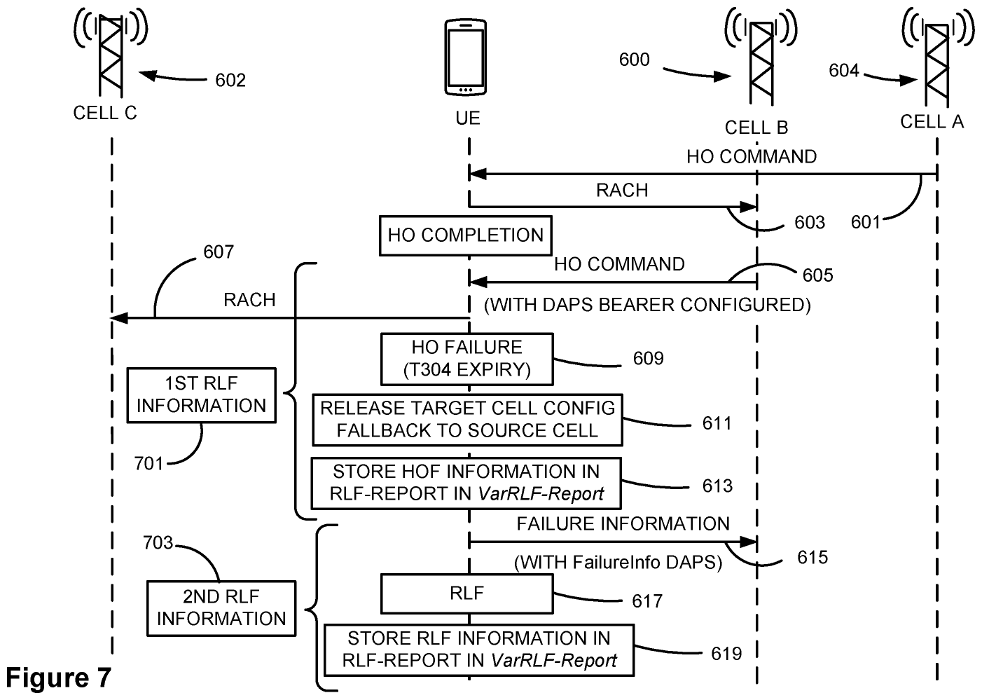

The association between the first and the second RLF reports and the information therein included is depicted in FIG. 7.

Turning to FIG. 7, the first RLF information 701 contains information about the HO failure to Cell C 602. The second RLF information 703 contains information about the RLF failure in the connection to Cell B 600.

FIGS. 8-12 illustrate various embodiments a wireless device (e.g., UE 2400) performs for reporting failure information in a self-organizing network (SON). Turning to FIG. 8, in block 801, the UE 2400 receives, from a source cell 600 while being connected to the source cell 600, a handover command to attempt a handover from the source cell 600 to a target cell 602, one or more bearers associated with the handover from the source cell 600 to the target cell 602 being configured with a dual active protocol stack, DAPS. This is analogous to the operations performed in block 605 in FIGS. 6 and 7.

In block 803, the UE 2400 experiences a failure while attempting the handover from the source cell 600 to the target cell 602. This is analogous to the operations performed in block 609 in FIGS. 6 and 7. In block 805, the UE 2400 stores first failure information associated with the failure while attempting the handover from the source cell 600 to the target cell 602. This is analogous to the operations performed in block 613 of FIGS. 6 and 7.

In block 807, the UE 2400 performs a DAPS fallback to the source cell 600 based at least in part on experiencing the failure while attempting the handover from the source cell 600 to the target cell 602. This is analogous to the operations performed in block 611 of FIGS. 6 and 7.

In block 809, the UE 2400 experiences a radio link failure (RLF) while being connected to the source cell 600. This is analogous to the operations performed in block 617 of FIGS. 6 and 7. In the various embodiments, the UE 2400 experiences the RLF while being connected to the source cell 600 after the DAPS fallback.

In block 811, the UE 2400 stores second failure information associated with experiencing the RLF.

In block 813, the UE 2400 transmits the first failure information or the second failure information towards the self-organizing network.

FIGS. 10-19 illustrate various embodiments of storing the failure information.

The first failure information or the second failure information can be stored in a radio link failure report. This is illustrated in FIG. 10.

Turning to FIG. 10, in block 1001, the UE 2400 stores the first failure information in a radio link failure, RLF, report or stores the second failure information includes storing the source failure information in the RLF report.

The following various embodiments disclose the information that the UE 2400 shall store in the RLF report included in the Var-RLF report to represent scenarios such as those described above and the related RL failures.

### Example Embodiments

In a first example embodiment, the second RLF-Report includes information related to the phase between the time the UE experienced HO failure for the HO from cell B 600 to cell C 602 (possibly also including information related to the time the UE has been connected in cell B 600 after HO from cell A 604), to the time the UE experiences the RLF in cell B 600, e.g., information collected in the time between step 5 and step 9.

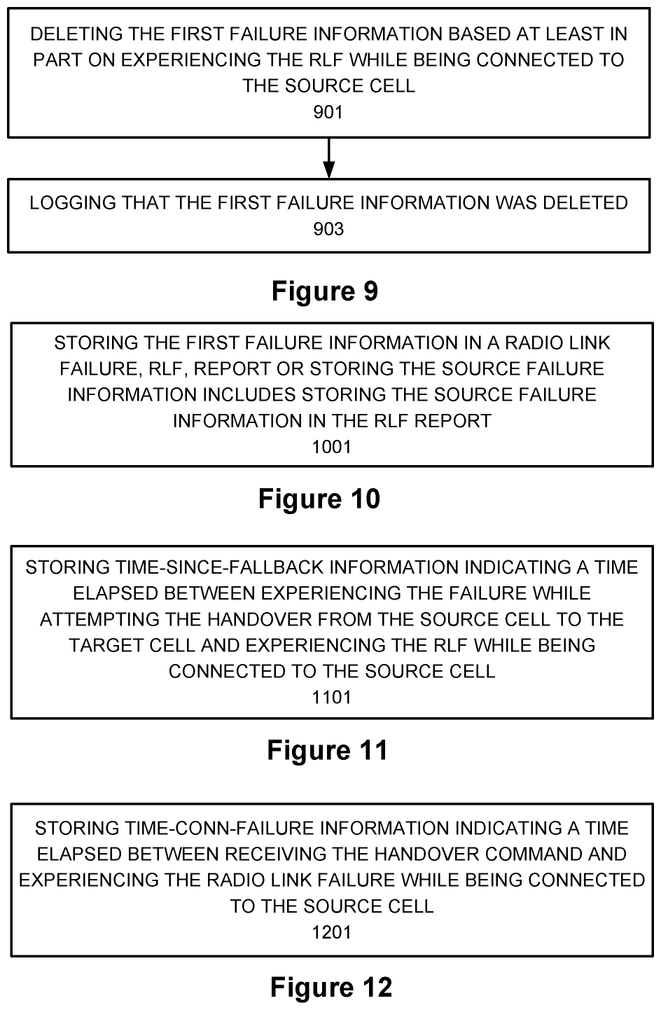

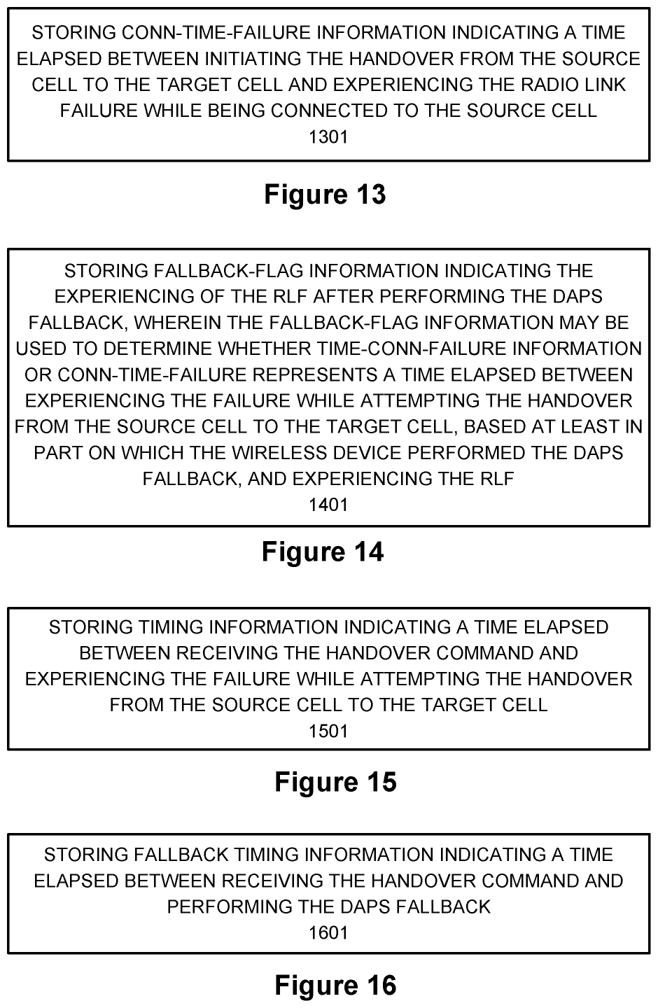

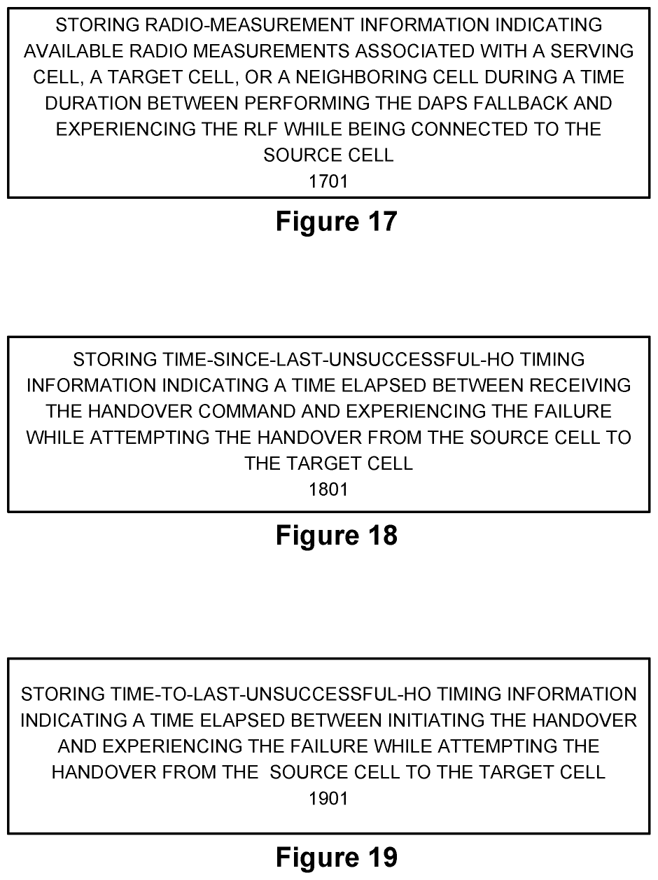

Such second RLF-Report may include any of the following information:
timeSinceFallback: The time elapsed between the fallback, e.g., the time the UE 2400 transmitted the FailureInformation message containing DAPS failure indication, or the time in which the UE 2400 declared HOF, and the said RLF. This is illustrated in block 1101 of FIG. 11 where storing the second failure information includes storing time-since-fallback information indicating a time elapsed between experiencing the failure while attempting the handover from the source cell 600 to the target cell 602 and experiencing the RLF while being connected to the source cell 600.
timeConnFailure (legacy timer): The time elapsed between the reception of the last RRCReconfiguration message including reconfigurationWithSync, irrespective of whether the corresponding handover execution was successful or not and the said RLF. FIGS. 12 and 13 illustrate various embodiments based on the timeConnFailure. In block 1201 of FIG. 12, the UE 2400 stores time-conn-failure information indicating a time elapsed between receiving the handover command and experiencing the radio link failure while being connected to the source cell 600. In block 1301 of FIG. 13, the UE 2400 stores conn-time-failure information indicating a time elapsed between initiating the handover from the source cell 600 to the target cell 602 and experiencing the radio link failure while being connected to the source cell 600;
fallbackFlag: A flag indicating that the RLF occurred after fallback, wherein the flag can be used by the network to determine whether the timeConnFailure represents the time between the said RLF and a handover execution that was not successful upon which the UE 2400 performed a fallback (e.g., the handover from cell B 600 to cell C 602), or the time between the said RLF and a handover execution that was successful (e.g., the handover from cell A 604 to cell B 600). Similarly, the network will determine in this way that the included radio measurements were collected after a fallback event. This is illustrated in block 1401 of FIG. 14 where the UE 2400 stores fallback-flag information indicating the experiencing of the RLF after performing the DAPS fallback, wherein the fallback-flag information may be used to determine whether time-conn-failure information or conn-time-failure represents a time elapsed between experiencing the failure while attempting the handover from the source cell 600 to the target cell 602, based at least in part on which the wireless device performed the DAPS fallback, and experiencing the RLF;
timeSinceLastSuccHO: The time elapsed between the reception of the last RRCReconfiguration message including reconfigurationWithSync that resulted in a successful handover execution until the RLF is experienced. In this case, this is the time elapsed between the RRCReconfiguration message including reconfigurationWithSync received from cell A 604 until the RLF in cell B 600 is experienced. Hence in this case, the said second RLF report also includes information associated to the time the UE 2400 has been connected to cell B 600 since the HO from cell A 604;
Information that provides the time elapsed between receiving the handover command and experiencing the failure while attempting the handover from the source cell 600 to the target cell 602. This is illustrated in block 1501 of FIG. 15 where the UE 2400 stores timing information indicating a time elapsed between receiving the handover command and experiencing the failure while attempting the handover from the source cell 600 to the target cell 602;
Information that provides the time elapsed between receiving the handover command and performing the DAPS fallback. This is illustrated in block 1601 of FIG. 16 where the UE 2400 stores fallback timing information indicating a time elapsed between receiving the handover command and performing the DAPS fallback;
Latest available radio measurements of serving cell, target cell and neighbouring cell after the fallback to cell B 600, and before the RLF in cell B 600; This is illustrated by block 1701 of FIG. 17 where the UE 2400 stores radio-measurement information indicating available radio measurements associated with a serving cell, a target cell, or a neighboring cell during a time duration between performing the DAPS fallback and experiencing the RLF while being connected to the source cell;
Information the provides the time elapsed from the reception of HO command that resulted in disconnection from the source (time of receiving the HO command in Cell A) to the time of receiving the DAPS HO command (time of receiving the DAPS HO command in Cell B);
Information related to the cell identifier associated in which the said HO commands were received (Cell A and Cell B);
If UE 2400 cleared the previous RLF report, the UE 2400 logs that it cleared the content of the previous RLF report for the RLF report variable. This is illustrated in FIG. 9 where the UE 2400 in block 901 deletes the first failure information based at least in part on experiencing the RLF while being connected to the source cell 600. In block 903, the UE 2400 logs that the first failure information was deleted.

In a second example embodiment, UE 2400 logs the time between two consecutive failures, e.g., time elapsed between the first failure and the second failure in which the second failure is the failure that triggered clearing/deleting the content of the first RLF report from VarRLF-Report

This indication (i.e., time between two consecutive failures) can be used by the network to fetch the content of the RLF reports as soon as possible, otherwise consecutive failures may ruin the previous failure information, impeding the network to optimize the DAPS HO configuration to avoid such failures in the future

In this second example embodiment, the first RLF-Report includes information related to the HO failure, e.g., related to the phase in which the UE 2400 was connected to cell B 600 including the phase between the time the UE 2400 received the HO command for HO to cell C 602, and the time the HO failure was experienced, or until the fallback was performed. For example, such first RLF report may include the following information:
timeSinceLastSuccHOandNextUnsuccHO: The time elapsed between the reception of the last RRCReconfiguration message including reconfigurationWithSync that results in a successful handover execution until the HOF or until the reception of the last RRCReconfiguration message including reconfigurationWithSync that results in an unsuccessful handover execution;
Latest available radio measurements of serving cell, target cell and neighbouring cell before the HO execution;
timeSinceLastUnsuccHO: The time elapsed between the reception of the last RRCReconfiguration message including reconfigurationWithSync that results in an unsuccessful handover execution until the HOF is experienced, i.e., the time elapsed between the reception of the HO command for HO from cell B 600 to cell C 602 and the HOF in cell B 600. This is illustrated in block 1801 of FIG. 18 where the UE 2400 stores time-since-last-unsuccessful-HO timing information indicating a time elapsed between receiving the handover command and experiencing the failure while attempting the handover from the source cell to the target cell.
Information that provides the time elapsed between initiating the handover and experiencing the failure while attempting the handover from the source cell 600 to the target cell 602. This is illustrated in block 1901 of FIG. 19 where the UE 2400 stores time-to-last-unsuccessful-HO timing information indicating a time elapsed between initiating the handover and experiencing the failure while attempting the handover from the source cell 600 to the target cell 602.
Information that provides the time elapsed from the reception of HO command that resulted in disconnection from the source (time of receiving the HO command in Cell A 604) to the time of receiving the DAPS HO command (time of receiving the DAPS HO command in Cell B 600);
Information related to the cell identifier associated in which the said HO commands were received (Cell A 604 and Cell B 600).

In one method, the UE logs in the VarRLF-Report in a first entry the 1st RLF information 701 upon experiencing the HO failure for the HO from cell B 600 to cell C 602, or upon fallback. Upon experiencing the RLF in the cell B 600, the UE deletes the stored entry in VarRLF-Report, e.g., the 1st RLF information, and logs the 2nd RLF information 703 associated to the 2nd RLF. This is illustrated in FIG. 9 as described above.

In a second method, upon experiencing the RLF in cell B 600, the UE 2400 does not delete the stored entry representing the 1st RLF information 701. Rather the UE 2400 includes in the VarRLF-Report a second entry representing the 2nd RLF. This second method may be performed in case the UE 2400 experiences an RLF in the same cell in which the UE performed the fallback, e.g., the cell that transmitted the HO command that results in an unsuccessful HO. Otherwise, the first entry may be deleted in case the UE 2400 gets a third RLF in a cell different from cell B 600, or a second HO failure.

In a third method, the UE 2400 stores in VarRLF-Report in a first entry, the 1st RLF information 701 associated to a first RLF report upon experiencing the HO failure for the HO from cell B 600 to cell C 602, or failure upon fallback from cell C 602 to cell B 600. The UE 2400 appends to such first entry, the information representing the 2nd RLF information 703 upon experiencing the RLF in cell B 600. This third method may be performed in case the UE 2400 experiences an RLF in the same cell in which the UE 2400 performed the fallback, e.g., the cell that transmitted the HO command that results in an unsuccessful HO.

In a fourth method, similar to the first method, the UE 2400 logs in the VarRLF-Report in a first entry the 1st RLF information 701 upon experiencing the HO failure for the HO from cell B 600 to cell C 602, or upon fallback. Upon experiencing the RLF in the cell B 600, the UE 2400 deletes the stored entry in VarRLF-Report, e.g., the 1st RLF information 701, and logs the information associated to the 2nd RLF, e.g., the 2nd RLF information 703. Additionally, in the second RLF report, the UE 2400 also includes information related to the previous successfully completed handover e.g., the information related to the handover from Cell-A to Cell-B. The UE includes the source cell of such a handover (Cell A) and the time elapsed since such a handover to the time of declaring failure (time between HO command reception from Cell-A to the time of RLF in Cell B 600).
Upon deleting/clearing the previous stored entry in VarRLF-Report, the UE 2400 logs that the 2400 cleared the content of the previous RLF report for the RLF report variable.
   This indication of clearing can be used by the network to fetch the content of the RLF reports as soon as possible, otherwise consecutive failures may ruin the previous failure information, impeding the network to optimize the DAPS HO configuration to avoid such failures in the future.

### Example Network Embodiments

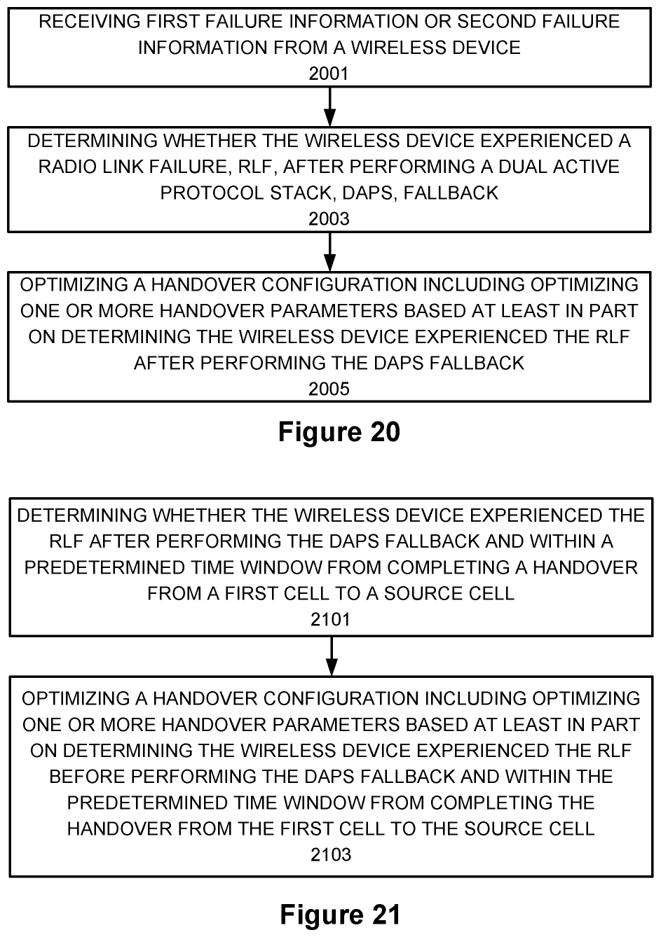

FIGS. 20-22 illustrate various embodiments of operations a base station 2360, 2520, 2612A, 2612B, 2612C, 2720 in the SON may perform. In the description that follows base station 2360 shall be used to describe the operations

Turning to FIG. 20, in block 2001, the base station 2360 receives first failure information or second failure information from a wireless device.

Upon receiving the information (first failure information and/or the second failure information) included in the above embodiment, the network (e.g., a base station) will be able to optimize the HO configuration and related parameters for the HO from cell A to cell B 600, for the HO from cell B 600 to cell C 602, for the HO from cell B 600 to a fourth cell, e.g., cell D

For example, if from the above information, the network determines that the RLF occurred after the fallback, the network may categorize such failure as “too late HO” for the cell B 600 that did not trigger an HO early enough to another cell. Thus, the base station 2360 determines in block 2003 whether the wireless device experience a radio link failure, RLF, after performing a dual active protocol stack, DAPS, fallback. In block 2005, the base station 2360 optimizes a handover configuration including optimizing one or more handover parameters based at least in part on determining the wireless device experienced the RLF after performing the DAPS fallback.

In another example, if from the above information, the network determines that the RLF occurred before the fallback, and within a time window from the last successful HO from cell A to cell B 600, the UE 2400 may categorize such failure as “too early HO” for the HO from cell A to cell B 600. Thus, turning to FIG. 21, in block 2101, the base station 2360 determines whether the wireless device experienced the RLF before performing the DAPS fallback and within a predetermined time window from completing a handover from a first cell to a source cell. In block 2103, the base station 2360 optimizes a handover configuration including optimizing one or more handover parameters based at least in part on determining the wireless device experienced the RLF before performing the DAPS fallback and within the predetermined time window from completing the handover from the first cell to the source cell.

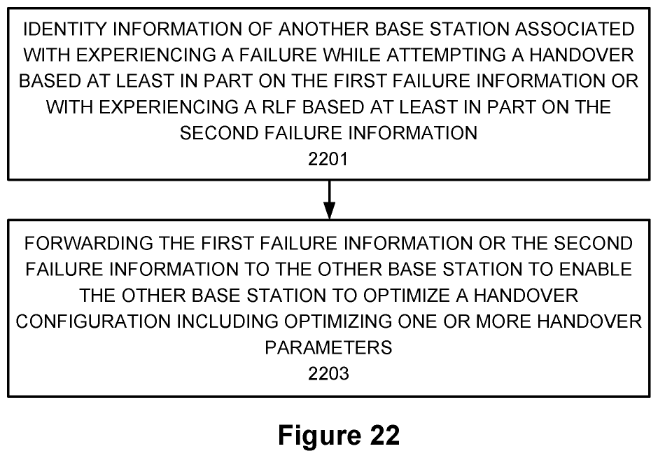

In yet another example, a network node (e.g., a base station or a management node) may receive the first failure information and/or the second failure information and may determine, based at least in part on the received information, an identity of a base station associated with experiencing a failure while attempting a handover or associated with experiencing a radio link failure. In some aspects, the network node may determine the identity of the base station based at least in part on cell information included in the received information. The network node may forward the received information to the determined base station. In this way, the network node may enable the base station to determine failure information such as, for example, (i) that the RLF occurred before the fallback, and within a time window from the last successful HO from cell A to cell B 600 or (ii) that the RLF occurred after the fallback, and to optimize a handover configuration including optimizing one or more handover parameters based at least in part on determining the failure information. This is illustrated in FIG. 22. Turning to FIG. 22, in block 2201, the base station 2360 determines identity information of another base station associated with experiencing a failure while attempting a handover based at least in part on the first failure information or with experiencing a RLF based at least in part on the second failure information. In block 2203, the base station 2360 forwards the first failure information or the second failure information to the other base station to enable the other base station to optimize a handover configuration including optimizing one or more handover parameters.

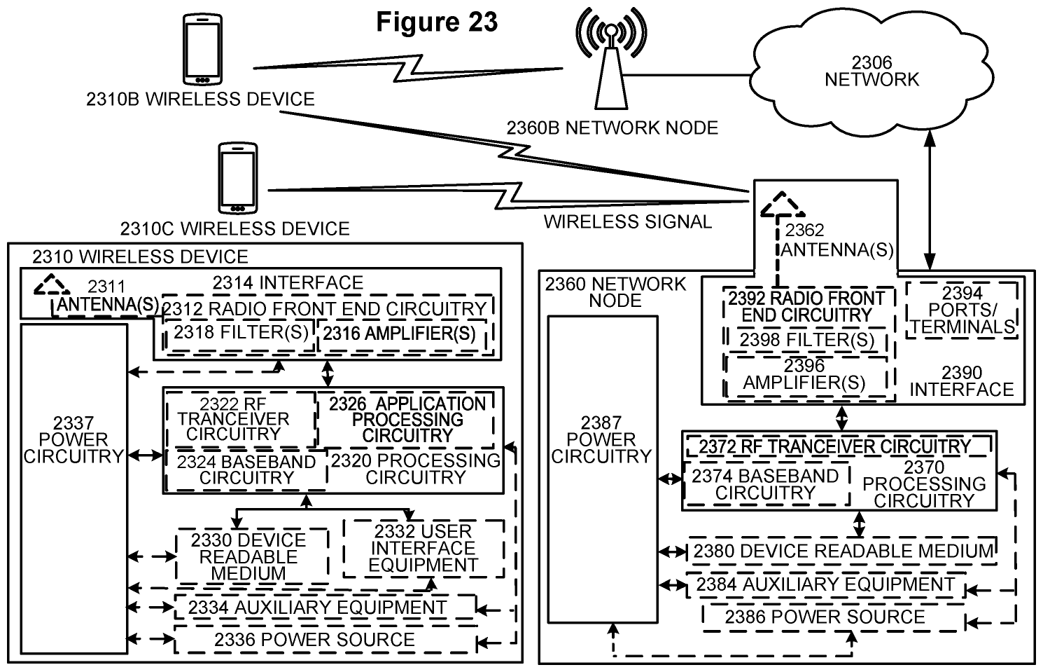

Although the subject matter described herein may be implemented in any appropriate type of system using any suitable components, the embodiments disclosed herein are described in relation to a wireless network, such as the example wireless network illustrated in FIG. 23. For simplicity, the wireless network of FIG. 23 depicts network 2306, network nodes 2360 and 2360B, and wireless devices (e.g., UEs) 2310, 2310B, and 2310C. In practice, a wireless network may further include any additional elements suitable to support communication between wireless devices or between a wireless device and another communication device, such as a landline telephone, a service provider, or any other network node or end device. Of the illustrated components, network node 2360 and wireless device (WD) 2310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2360 and WD 2310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 23, network node 2360 includes processing circuitry 2370, device readable medium 2380, interface 2390, auxiliary equipment 2384, power source 2386, power circuitry 2387, and antenna 2362. Although network node 2360 illustrated in the example wireless network of FIG. 23 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2360 are depicted as single boxes located within a larger box, or nested within multiple boxes, in practice, a network node may comprise multiple different physical components that make up a single illustrated component (e.g., device readable medium 2380 may comprise multiple separate hard drives as well as multiple RAM modules).

Similarly, network node 2360 may be composed of multiple physically separate components (e.g., a NodeB component and a RNC component, or a BTS component and a BSC component, etc.), which may each have their own respective components. In certain scenarios in which network node 2360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2360 may be configured to support multiple radio access technologies (RATs). In such embodiments, some components may be duplicated (e.g., separate device readable medium 2380 for the different RATs) and some components may be reused (e.g., the same antenna 2362 may be shared by the RATs). Network node 2360 may also include multiple sets of the various illustrated components for different wireless technologies integrated into network node 2360, such as, for example, GSM, WCDMA, LTE, NR, WiFi, or Bluetooth wireless technologies. These wireless technologies may be integrated into the same or different chip or set of chips and other components within network node 2360.

Processing circuitry 2370 is configured to perform any determining, calculating, or similar operations (e.g., certain obtaining operations) described herein as being provided by a network node. These operations performed by processing circuitry 2370 may include processing information obtained by processing circuitry 2370 by, for example, converting the obtained information into other information, comparing the obtained information or converted information to information stored in the network node, and/or performing one or more operations based on the obtained information or converted information, and as a result of said processing making a determination.

Processing circuitry 2370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2360 components, such as device readable medium 2380, network node 2360 functionality. For example, processing circuitry 2370 may execute instructions stored in device readable medium 2380 or in memory within processing circuitry 2370. Such functionality may include providing any of the various wireless features, functions, or benefits discussed herein. In some embodiments, processing circuitry 2370 may include a system on a chip (SOC).

In some embodiments, processing circuitry 2370 may include one or more of radio frequency (RF) transceiver circuitry 2372 and baseband processing circuitry 2374. In some embodiments, radio frequency (RF) transceiver circuitry 2372 and baseband processing circuitry 2374 may be on separate chips (or sets of chips), boards, or units, such as radio units and digital units. In alternative embodiments, part or all of RF transceiver circuitry 2372 and baseband processing circuitry 2374 may be on the same chip or set of chips, boards, or units

In certain embodiments, some or all of the functionality described herein as being provided by a network node, base station, eNB or other such network device may be performed by processing circuitry 2370 executing instructions stored on device readable medium 2380 or memory within processing circuitry 2370. In alternative embodiments, some or all of the functionality may be provided by processing circuitry 2370 without executing instructions stored on a separate or discrete device readable medium, such as in a hard-wired manner In any of those embodiments, whether executing instructions stored on a device readable storage medium or not, processing circuitry 2370 can be configured to perform the described functionality. The benefits provided by such functionality are not limited to processing circuitry 2370 alone or to other components of network node 2360, but are enjoyed by network node 2360 as a whole, and/or by end users and the wireless network generally.

Device readable medium 2380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2370. Device readable medium 2380 may store any suitable instructions, data or information, including a computer program, software, an application including one or more of logic, rules, code, tables, etc. and/or other instructions capable of being executed by processing circuitry 2370 and, utilized by network node 2360. Device readable medium 2380 may be used to store any calculations made by processing circuitry 2370 and/or any data received via interface 2390. In some embodiments, processing circuitry 2370 and device readable medium 2380 may be considered to be integrated.

Interface 2390 is used in the wired or wireless communication of signalling and/or data between network node 2360, network 2306, and/or WDs 2310. As illustrated, interface 2390 comprises port(s)/terminal(s) 2394 to send and receive data, for example to and from network 2306 over a wired connection. Interface 2390 also includes radio front end circuitry 2392 that may be coupled to, or in certain embodiments a part of, antenna 2362. Radio front end circuitry 2392 comprises filters 2398 and amplifiers 2396. Radio front end circuitry 2392 may be connected to antenna 2362 and processing circuitry 2370. Radio front end circuitry may be configured to condition signals communicated between antenna 2362 and processing circuitry 2370. Radio front end circuitry 2392 may receive digital data that is to be sent out to other network nodes or WDs via a wireless connection. Radio front end circuitry 2392 may convert the digital data into a radio signal having the appropriate channel and bandwidth parameters using a combination of filters 2398 and/or amplifiers 2396. The radio signal may then be transmitted via antenna 2362. Similarly, when receiving data, antenna 2362 may collect radio signals which are then converted into digital data by radio front end circuitry 2392. The digital data may be passed to processing circuitry 2370. In other embodiments, the interface may comprise different components and/or different combinations of components.

In certain alternative embodiments, network node 2360 may not include separate radio front end circuitry 2392, instead, processing circuitry 2370 may comprise radio front end circuitry and may be connected to antenna 2362 without separate radio front end circuitry 2392. Similarly, in some embodiments, all or some of RF transceiver circuitry 2372 may be considered a part of interface 2390. In still other embodiments, interface 2390 may include one or more ports or terminals 2394, radio front end circuitry 2392, and RF transceiver circuitry 2372, as part of a radio unit (not shown), and interface 2390 may communicate with baseband processing circuitry 2374, which is part of a digital unit (not shown).

Antenna 2362 may include one or more antennas, or antenna arrays, configured to send and/or receive wireless signals. Antenna 2362 may be coupled to radio front end circuitry 2392 and may be any type of antenna capable of transmitting and receiving data and/or signals wirelessly. In some embodiments, antenna 2362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 2362 may be separate from network node 2360 and may be connectable to network node 2360 through an interface or port.

Antenna 2362, interface 2390, and/or processing circuitry 2370 may be configured to perform any receiving operations and/or certain obtaining operations described herein as being performed by a network node. Any information, data and/or signals may be received from a wireless device, another network node and/or any other network equipment. Similarly, antenna 2362, interface 2390, and/or processing circuitry 2370 may be configured to perform any transmitting operations described herein as being performed by a network node. Any information, data and/or signals may be transmitted to a wireless device, another network node and/or any other network equipment.

Power circuitry 2387 may comprise, or be coupled to, power management circuitry and is configured to supply the components of network node 2360 with power for performing the functionality described herein. Power circuitry 2387 may receive power from power source 2386. Power source 2386 and/or power circuitry 2387 may be configured to provide power to the various components of network node 2360 in a form suitable for the respective components (e.g., at a voltage and current level needed for each respective component). Power source 2386 may either be included in, or external to, power circuitry 2387 and/or network node 2360. For example, network node 2360 may be connectable to an external power source (e.g., an electricity outlet) via an input circuitry or interface such as an electrical cable, whereby the external power source supplies power to power circuitry 2387. As a further example, power source 2386 may comprise a source of power in the form of a battery or battery pack which is connected to, or integrated in, power circuitry 2387. The battery may provide backup power should the external power source fail. Other types of power sources, such as photovoltaic devices, may also be used.

Alternative embodiments of network node 2360 may include additional components beyond those shown in FIG. 23 that may be responsible for providing certain aspects of the network node's functionality, including any of the functionality described herein and/or any functionality necessary to support the subject matter described herein. For example, network node 2360 may include user interface equipment to allow input of information into network node 2360 and to allow output of information from network node 2360. This may allow a user to perform diagnostic, maintenance, repair, and other administrative functions for network node 2360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 2310 includes antenna 2311, interface 2314, processing circuitry 2320, device readable medium 2330, user interface equipment 2332, auxiliary equipment 2334, power source 2336 and power circuitry 2337. WD 2310 may include multiple sets of one or more of the illustrated components for different wireless technologies supported by WD 2310, such as, for example, GSM, WCDMA, LTE, NR, WiFi, WiMAX, or Bluetooth wireless technologies, just to mention a few. These wireless technologies may be integrated into the same or different chips or set of chips as other components within WD 2310. Antenna 2311 may include one or more antennas or antenna arrays, configured to send and/or receive wireless signals, and is connected to interface 2314. In certain alternative embodiments, antenna 2311 may be separate from WD 2310 and be connectable to WD 2310 through an interface or port. Antenna 2311, interface 2314, and/or processing circuitry 2320 may be configured to perform any receiving or transmitting operations described herein as being performed by a WD. Any information, data and/or signals may be received from a network node and/or another WD. In some embodiments, radio front end circuitry and/or antenna 2311 may be considered an interface.

As illustrated, interface 2314 comprises radio front end circuitry 2312 and antenna 2311. Radio front end circuitry 2312 comprise one or more filters 2318 and amplifiers 2316. Radio front end circuitry 2312 is connected to antenna 2311 and processing circuitry 2320, and is configured to condition signals communicated between antenna 2311 and processing circuitry 2320. Radio front end circuitry 2312 may be coupled to or a part of antenna 2311. In some embodiments, WD 2310 may not include separate radio front end circuitry 2312; rather, processing circuitry 2320 may comprise radio front end circuitry and may be connected to antenna 2311. Similarly, in some embodiments, some or all of RF transceiver circuitry 2322 may be considered a part of interface 2314. Radio front end circuitry 2312 may receive digital data that is to be sent out to other network nodes or WDs via a wireless connection. Radio front end circuitry 2312 may convert the digital data into a radio signal having the appropriate channel and bandwidth parameters using a combination of filters 2318 and/or amplifiers 2316. The radio signal may then be transmitted via antenna 2311. Similarly, when receiving data, antenna 2311 may collect radio signals which are then converted into digital data by radio front end circuitry 2312. The digital data may be passed to processing circuitry 2320. In other embodiments, the interface may comprise different components and/or different combinations of components.

Processing circuitry 2320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2310 components, such as device readable medium 2330, WD 2310 functionality. Such functionality may include providing any of the various wireless features or benefits discussed herein. For example, processing circuitry 2320 may execute instructions stored in device readable medium 2330 or in memory within processing circuitry 2320 to provide the functionality disclosed herein.

As illustrated, processing circuitry 2320 includes one or more of RF transceiver circuitry 2322, baseband processing circuitry 2324, and application processing circuitry 2326. In other embodiments, the processing circuitry may comprise different components and/or different combinations of components. In certain embodiments processing circuitry 2320 of WD 2310 may comprise a SOC. In some embodiments, RF transceiver circuitry 2322, baseband processing circuitry 2324, and application processing circuitry 2326 may be on separate chips or sets of chips. In alternative embodiments, part or all of baseband processing circuitry 2324 and application processing circuitry 2326 may be combined into one chip or set of chips, and RF transceiver circuitry 2322 may be on a separate chip or set of chips. In still alternative embodiments, part or all of RF transceiver circuitry 2322 and baseband processing circuitry 2324 may be on the same chip or set of chips, and application processing circuitry 2326 may be on a separate chip or set of chips. In yet other alternative embodiments, part or all of RF transceiver circuitry 2322, baseband processing circuitry 2324, and application processing circuitry 2326 may be combined in the same chip or set of chips. In some embodiments, RF transceiver circuitry 2322 may be a part of interface 2314. RF transceiver circuitry 2322 may condition RF signals for processing circuitry 2320.

In certain embodiments, some or all of the functionality described herein as being performed by a WD may be provided by processing circuitry 2320 executing instructions stored on device readable medium 2330, which in certain embodiments may be a computer-readable storage medium. In alternative embodiments, some or all of the functionality may be provided by processing circuitry 2320 without executing instructions stored on a separate or discrete device readable storage medium, such as in a hard-wired manner In any of those particular embodiments, whether executing instructions stored on a device readable storage medium or not, processing circuitry 2320 can be configured to perform the described functionality. The benefits provided by such functionality are not limited to processing circuitry 2320 alone or to other components of WD 2310, but are enjoyed by WD 2310 as a whole, and/or by end users and the wireless network generally.

Processing circuitry 2320 may be configured to perform any determining, calculating, or similar operations (e.g., certain obtaining operations) described herein as being performed by a WD. These operations, as performed by processing circuitry 2320, may include processing information obtained by processing circuitry 2320 by, for example, converting the obtained information into other information, comparing the obtained information or converted information to information stored by WD 2310, and/or performing one or more operations based on the obtained information or converted information, and as a result of said processing making a determination.

Device readable medium 2330 may be operable to store a computer program, software, an application including one or more of logic, rules, code, tables, etc. and/or other instructions capable of being executed by processing circuitry 2320. Device readable medium 2330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2320. In some embodiments, processing circuitry 2320 and device readable medium 2330 may be considered to be integrated.

User interface equipment 2332 may provide components that allow for a human user to interact with WD 2310. Such interaction may be of many forms, such as visual, audial, tactile, etc. User interface equipment 2332 may be operable to produce output to the user and to allow the user to provide input to WD 2310. The type of interaction may vary depending on the type of user interface equipment 2332 installed in WD 2310. For example, if WD 2310 is a smart phone, the interaction may be via a touch screen; if WD 2310 is a smart meter, the interaction may be through a screen that provides usage (e.g., the number of gallons used) or a speaker that provides an audible alert (e.g., if smoke is detected). User interface equipment 2332 may include input interfaces, devices and circuits, and output interfaces, devices and circuits. User interface equipment 2332 is configured to allow input of information into WD 2310, and is connected to processing circuitry 2320 to allow processing circuitry 2320 to process the input information. User interface equipment 2332 may include, for example, a microphone, a proximity or other sensor, keys/buttons, a touch display, one or more cameras, a USB port, or other input circuitry. User interface equipment 2332 is also configured to allow output of information from WD 2310, and to allow processing circuitry 2320 to output information from WD 2310. User interface equipment 2332 may include, for example, a speaker, a display, vibrating circuitry, a USB port, a headphone interface, or other output circuitry. Using one or more input and output interfaces, devices, and circuits, of user interface equipment 2332, WD 2310 may communicate with end users and/or the wireless network, and allow them to benefit from the functionality described herein.

Auxiliary equipment 2334 is operable to provide more specific functionality which may not be generally performed by WDs. This may comprise specialized sensors for doing measurements for various purposes, interfaces for additional types of communication such as wired communications etc. The inclusion and type of components of auxiliary equipment 2334 may vary depending on the embodiment and/or scenario.

Power source 2336 may, in some embodiments, be in the form of a battery or battery pack. Other types of power sources, such as an external power source (e.g., an electricity outlet), photovoltaic devices or power cells, may also be used. WD 2310 may further comprise power circuitry 2337 for delivering power from power source 2336 to the various parts of WD 2310 which need power from power source 2336 to carry out any functionality described or indicated herein. Power circuitry 2337 may in certain embodiments comprise power management circuitry. Power circuitry 2337 may additionally or alternatively be operable to receive power from an external power source; in which case WD 2310 may be connectable to the external power source (such as an electricity outlet) via input circuitry or an interface such as an electrical power cable. Power circuitry 2337 may also in certain embodiments be operable to deliver power from an external power source to power source 2336. This may be, for example, for the charging of power source 2336. Power circuitry 2337 may perform any formatting, converting, or other modification to the power from power source 2336 to make the power suitable for the respective components of WD 2310 to which power is supplied.

FIG. 24 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 24200 may be any UE identified by the 3 rd Generation Partnership Project (3GPP), including a NB-IoT UE, a machine type communication (MTC) UE, and/or an enhanced MTC (eMTC) UE. UE 2400, as illustrated in FIG. 24, is one example of a WD configured for communication in accordance with one or more communication standards promulgated by the 3 rd Generation Partnership Project (3GPP), such as 3GPP's GSM, UMTS, LTE, and/or 5G standards. As mentioned previously, the term WD and UE may be used interchangeable. Accordingly, although FIG. 24 is a UE, the components discussed herein are equally applicable to a WD, and vice-versa.

In FIG. 24, UE 2400 includes processing circuitry 2401 that is operatively coupled to input/output interface 2405, radio frequency (RF) interface 2409, network connection interface 2411, memory 2415 including random access memory (RAM) 2417, read-only memory (ROM) 2419, and storage medium 2421 or the like, communication subsystem 2431, power source 2413, and/or any other component, or any combination thereof. Storage medium 2421 includes operating system 2423, application program 2425, and data 2427. In other embodiments, storage medium 2421 may include other similar types of information. Certain UEs may utilize all of the components shown in FIG. 24, or a subset of the components. The level of integration between the components may vary from one UE to another UE. Further, certain UEs may contain multiple instances of a component, such as multiple processors, memories, transceivers, transmitters, receivers, etc.

In FIG. 24, processing circuitry 2401 may be configured to process computer instructions and data. Processing circuitry 2401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2401 may include two central processing units (CPUs). Data may be information in a form suitable for use by a computer.

In the depicted embodiment, input/output interface 2405 may be configured to provide a communication interface to an input device, output device, or input and output device. UE 2400 may be configured to use an output device via input/output interface 2405. An output device may use the same type of interface port as an input device. For example, a USB port may be used to provide input to and output from UE 2400. The output device may be a speaker, a sound card, a video card, a display, a monitor, a printer, an actuator, an emitter, a smartcard, another output device, or any combination thereof. UE 2400 may be configured to use an input device via input/output interface 2405 to allow a user to capture information into UE 2400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 24, RF interface 2409 may be configured to provide a communication interface to RF components such as a transmitter, a receiver, and an antenna. Network connection interface 2411 may be configured to provide a communication interface to network 2443A. Network 2443A may encompass wired and/or wireless networks such as a local-area network (LAN), a wide-area network (WAN), a computer network, a wireless network, a telecommunications network, another like network or any combination thereof. For example, network 2443A may comprise a Wi-Fi network. Network connection interface 2411 may be configured to include a receiver and a transmitter interface used to communicate with one or more other devices over a communication network according to one or more communication protocols, such as Ethernet, TCP/IP, SONET, ATM, or the like. Network connection interface 2411 may implement receiver and transmitter functionality appropriate to the communication network links (e.g., optical, electrical, and the like). The transmitter and receiver functions may share circuit components, software or firmware, or alternatively may be implemented separately.

RAM 2417 may be configured to interface via bus 2402 to processing circuitry 2401 to provide storage or caching of data or computer instructions during the execution of software programs such as the operating system, application programs, and device drivers. ROM 2419 may be configured to provide computer instructions or data to processing circuitry 2401. For example, ROM 2419 may be configured to store invariant low-level system code or data for basic system functions such as basic input and output (I/O), startup, or reception of keystrokes from a keyboard that are stored in a non-volatile memory. Storage medium 2421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2421 may be configured to include operating system 2423, application program 2425 such as a web browser application, a widget or gadget engine or another application, and data file 2427. Storage medium 2421 may store, for use by UE 2400, any of a variety of various operating systems or combinations of operating systems.

Storage medium 2421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2421 may allow UE 2400 to access computer-executable instructions, application programs or the like, stored on transitory or non-transitory memory media, to off-load data, or to upload data. An article of manufacture, such as one utilizing a communication system may be tangibly embodied in storage medium 2421, which may comprise a device readable medium.

In FIG. 24, processing circuitry 2401 may be configured to communicate with network 2443B using communication subsystem 2431. Network 2443A and network 2443B may be the same network or networks or different network or networks. Communication subsystem 2431 may be configured to include one or more transceivers used to communicate with network 2443B. For example, communication subsystem 2431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 2433 and/or receiver 2435 to implement transmitter or receiver functionality, respectively, appropriate to the RAN links (e.g., frequency allocations and the like). Further, transmitter 2433 and receiver 2435 of each transceiver may share circuit components, software or firmware, or alternatively may be implemented separately.

In the illustrated embodiment, the communication functions of communication subsystem 2431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2431 may include cellular communication, Wi-Fi communication, Bluetooth communication, and GPS communication. Network 2443b may encompass wired and/or wireless networks such as a local-area network (LAN), a wide-area network (WAN), a computer network, a wireless network, a telecommunications network, another like network or any combination thereof. For example, network 2443B may be a cellular network, a Wi-Fi network, and/or a near-field network. Power source 2413 may be configured to provide alternating current (AC) or direct current (DC) power to components of UE 2400.

The features, benefits and/or functions described herein may be implemented in one of the components of UE 2400 or partitioned across multiple components of UE 2400. Further, the features, benefits, and/or functions described herein may be implemented in any combination of hardware, software or firmware. In one example, communication subsystem 2431 may be configured to include any of the components described herein. Further, processing circuitry 2401 may be configured to communicate with any of such components over bus 2402. In another example, any of such components may be represented by program instructions stored in memory that when executed by processing circuitry 2401 perform the corresponding functions described herein. In another example, the functionality of any of such components may be partitioned between processing circuitry 2401 and communication subsystem 2431. In another example, the non-computationally intensive functions of any of such components may be implemented in software or firmware and the computationally intensive functions may be implemented in hardware.

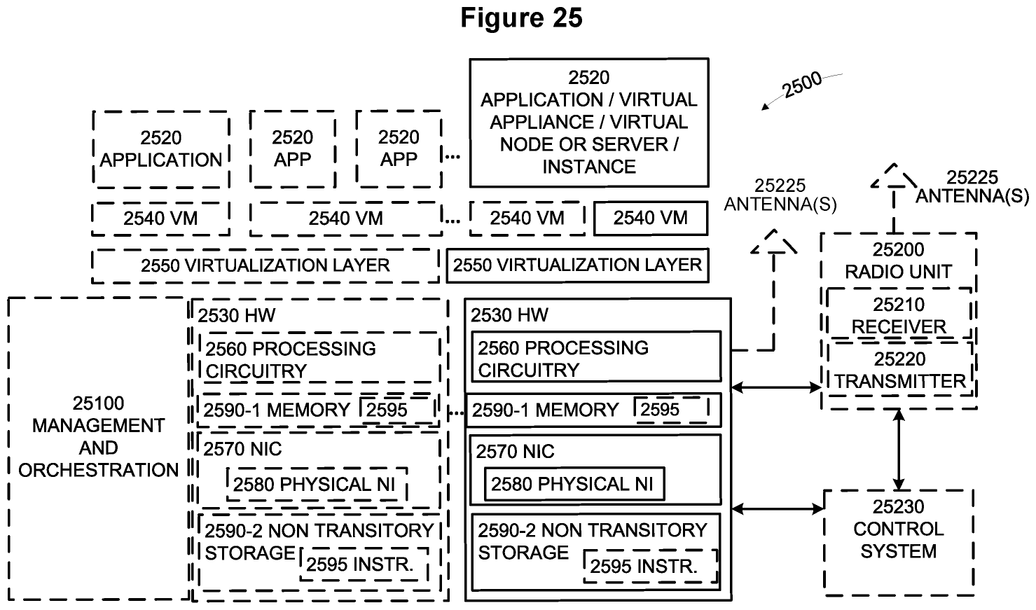

FIG. 25 is a schematic block diagram illustrating a virtualization environment 2500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2500 hosted by one or more of hardware nodes 2530. Further, in embodiments in which the virtual node is not a radio access node or does not require radio connectivity (e.g., a core network node), then the network node may be entirely virtualized.

The functions may be implemented by one or more applications 2520 (which may alternatively be called software instances, virtual appliances, network functions, virtual nodes, virtual network functions, etc.) operative to implement some of the features, functions, and/or benefits of some of the embodiments disclosed herein. Applications 2520 are run in virtualization environment 2500 which provides hardware 2530 comprising processing circuitry 2560 and memory 2590. Memory 2590 contains instructions 2595 executable by processing circuitry 2560 whereby application 2520 is operative to provide one or more of the features, benefits, and/or functions disclosed herein.

Virtualization environment 2500, comprises general-purpose or special-purpose network hardware devices 2530 comprising a set of one or more processors or processing circuitry 2560, which may be commercial off-the-shelf (COTS) processors, dedicated Application Specific Integrated Circuits (ASICs), or any other type of processing circuitry including digital or analog hardware components or special purpose processors. Each hardware device may comprise memory 2590-1 which may be non-persistent memory for temporarily storing instructions 2595 or software executed by processing circuitry 2560. Each hardware device may comprise one or more network interface controllers (NICs) 2570, also known as network interface cards, which include physical network interface 2580. Each hardware device may also include non-transitory, persistent, machine-readable storage media 2590-2 having stored therein software 2595 and/or instructions executable by processing circuitry 2560. Software 2595 may include any type of software including software for instantiating one or more virtualization layers 2550 (also referred to as hypervisors), software to execute virtual machines 2540 as well as software allowing it to execute functions, features and/or benefits described in relation with some embodiments described herein.

Virtual machines 2540, comprise virtual processing, virtual memory, virtual networking or interface and virtual storage, and may be run by a corresponding virtualization layer 2550 or hypervisor. Different embodiments of the instance of virtual appliance 2520 may be implemented on one or more of virtual machines 2540, and the implementations may be made in different ways.

During operation, processing circuitry 2560 executes software 2595 to instantiate the hypervisor or virtualization layer 2550, which may sometimes be referred to as a virtual machine monitor (VMM). Virtualization layer 2550 may present a virtual operating platform that appears like networking hardware to virtual machine 2540.

As shown in FIG. 25, hardware 2530 may be a standalone network node with generic or specific components. Hardware 2530 may comprise antenna 25225 and may implement some functions via virtualization. Alternatively, hardware 2530 may be part of a larger cluster of hardware (e.g., such as in a data center or customer premise equipment (CPE)) where many hardware nodes work together and are managed via management and orchestration (MANO) 25100, which, among others, oversees lifecycle management of applications 2520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2540 may be a software implementation of a physical machine that runs programs as if they were executing on a physical, non-virtualized machine. Each of virtual machines 2540, and that part of hardware 2530 that executes that virtual machine, be it hardware dedicated to that virtual machine and/or hardware shared by that virtual machine with others of the virtual machines 2540, forms a separate virtual network elements (VNE).

Still in the context of NFV, Virtual Network Function (VNF) is responsible for handling specific network functions that run in one or more virtual machines 2540 on top of hardware networking infrastructure 2530 and corresponds to application 2520 in FIG. 25.

In some embodiments, one or more radio units 25200 that each include one or more transmitters 25220 and one or more receivers 25210 may be coupled to one or more antennas 25225. Radio units 25200 may communicate directly with hardware nodes 2530 via one or more appropriate network interfaces and may be used in combination with the virtual components to provide a virtual node with radio capabilities, such as a radio access node or a base station.

In some embodiments, some signalling can be effected with the use of control system 25230 which may alternatively be used for communication between the hardware nodes 2530 and radio units 25200.

### EMBODIMENTS

### Group A Embodiments

1. A method performed by a wireless device for reporting failure information in a self-organizing network (SON), the method comprising:
receiving, from a first cell, a first handover command to attempt a handover from the first cell to a second cell;
completing the handover from the first cell to the second cell based at least in part on the first handover command;
receiving, from the second cell while being connected to the second cell, a second handover command to attempt a handover from the second cell to a third cell, one or more bearers associated with the handover from the second cell to the third cell being configured with a dual active protocol stack (DAPS);
experiencing a failure while attempting the handover from the second cell to the third cell;
storing first failure information associated with the failure while attempting the handover from the second cell to the third cell;
performing a DAPS fallback to the second cell based at least in part on experiencing the failure while attempting the handover from the second cell to the third cell;
experiencing a radio link failure while being connected to the second cell;
storing second failure information associated with experiencing the radio link failure; and
transmitting the first failure information or the second failure information.
   2. The method of embodiment 1, further comprising:
deleting the first failure information based at least in part on experiencing the radio link failure while being connected to the second cell.
   3. The method of embodiment 1, further comprising:—
deleting the first failure information based at least in part on experiencing a radio link failure while attempting a handover to a fourth cell.
   4. The method of embodiment 1, further comprising:
deleting the first failure information based at least in part on experiencing another handover failure.
   5. The method of embodiment 1, wherein storing the second failure information includes appending the second failure information to the first failure information.
   6. The method of embodiment 1, wherein storing the second failure information includes storing handover information associated with completing the handover from the first cell to the second cell.
   7. The method of embodiment 1, further comprising:—
deleting the first failure information and logging information associated with deleting the first failure information.
   8. The method of any of the previous embodiments, wherein storing the first failure information includes storing the first failure information in a radio link failure (RLF) report or storing the second failure information includes storing the second failure information in the RLF report.
   9. The method of any of the previous embodiments, wherein storing the second failure information includes storing time-since-fallback information indicating a time elapsed between experiencing the failure while attempting the handover from the second cell to the third cell and experiencing the radio link failure while being connected to the second cell.
   10. The method of any of the previous embodiments, wherein storing the second failure information includes storing time-conn-failure information indicating a time elapsed between receiving the second handover command and experiencing the radio link failure while being connected to the second cell.
   11. The method of any of the previous embodiments, wherein storing the second failure information includes storing fallback-flag information indicating the experiencing of the radio link failure after performing the DAPS fallback, wherein the fallback-flag information may be used to determine whether time-conn-failure information represents a time elapsed between experiencing the failure while attempting the handover from the second cell to the third cell, based at least in part on which the wireless device performed the DAPS fallback, and experiencing the radio link failure.
   12. The method of any of the previous embodiments, wherein storing the second failure information includes storing radio-measurement information indicating available radio measurements associated with a serving cell, a target cell, or a neighboring cell during a time duration between performing the DAPS fallback and experiencing the radio link failure while being connected to the second cell.
   13. The method of any of the previous embodiments, wherein storing the second failure information includes storing time-since-last-successful-HO information indicating a time elapsed between completing the handover from the first cell to the second cell and experiencing the radio link failure while being connected to the second cell.
   14. The method of any of the previous embodiments, further comprising:
logging consecutive-failure-time information indicating a time elapsed between two consecutive failures including a first failure and a second failure, the second failure triggering deletion of the first failure information.
   15. The method of any of the previous embodiments, wherein storing the second failure information includes storing time-since-last-unsuccessful-HO information indicating a time elapsed between receiving the second handover command and experiencing the failure while attempting the handover from the second cell to the third cell.
   16. The method of any of the previous embodiments, further comprising:
providing user data; and
forwarding the user data to a host computer via the transmission to the base station.

### Group B Embodiments

17. A method performed by a base station, the method comprising:
receiving first failure information or second failure information from a wireless device;
determining that the wireless device experienced the radio link failure before performing the DAPS fallback and within a predetermined time window from completing the handover from the first cell to the second cell; and
optimizing a handover configuration including optimizing one or more handover parameters based at least in part on the determination.
   18. A method performed by a base station, the method comprising:
receiving first failure information or second failure information from a wireless device;
determining that the wireless device experienced the radio link failure after performing the DAPS fallback; and
optimizing a handover configuration including optimizing one or more handover parameters based at least in part on the determination.
   19. A method performed by a base station, the method comprising:
receiving first failure information or second failure information from a wireless device;
determining identity information of another base station associated with experiencing a failure while attempting a handover based at least in part on the first failure information or with experiencing a radio link failure based at least in part on the second failure information; and
forwarding the first failure information or the second failure information to the other base station to enable the other base station to optimize a handover configuration including optimizing one or more handover parameters.
   20. The method of any of the previous embodiments, further comprising:
obtaining user data; and
forwarding the user data to a host computer or a wireless device.

### Group C Embodiments

21. A wireless device for reporting failure information in a self-organizing network (SON), the wireless device comprising:
processing circuitry configured to perform any of the steps of any of the Group A embodiments; and
power supply circuitry configured to supply power to the wireless device.
   22. A base station, comprising:
processing circuitry configured to perform any of the steps of any of the Group B embodiments;
power supply circuitry configured to supply power to the base station.
   23. A user equipment (UE) for reporting failure information in a self-organizing network (SON), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   24. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   25. The communication system of the previous embodiment further including the base station.
   26. The communication system of the previous 2 embodiments, further including the UE, wherein the UE is configured to communicate with the base station.
   27. The communication system of the previous 3 embodiments, wherein:
the processing circuitry of the host computer is configured to execute a host application, thereby providing the user data; and
the UE comprises processing circuitry configured to execute a client application associated with the host application.
   28. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   29. The method of the previous embodiment, further comprising, at the base station, transmitting the user data.
   30. The method of the previous 2 embodiments, wherein the user data is provided at the host computer by executing a host application, the method further comprising, at the UE, executing a client application associated with the host application.
   31. A user equipment (UE) configured to communicate with a base station, the UE comprising a radio interface and processing circuitry configured to performs the of the previous 3 embodiments.
   32. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   33. The communication system of the previous embodiment, wherein the cellular network further includes a base station configured to communicate with the UE.
   34. The communication system of the previous 2 embodiments, wherein:
the processing circuitry of the host computer is configured to execute a host application, thereby providing the user data; and
the UE's processing circuitry is configured to execute a client application associated with the host application.
   35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   36. The method of the previous embodiment, further comprising at the UE, receiving the user data from the base station.
   37. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   38. The communication system of the previous embodiment, further including the UE.
   39. The communication system of the previous 2 embodiments, further including the base station, wherein the base station comprises a radio interface configured to communicate with the UE and a communication interface configured to forward to the host computer the user data carried by a transmission from the UE to the base station.
   40. The communication system of the previous 3 embodiments, wherein:
the processing circuitry of the host computer is configured to execute a host application; and
the UE's processing circuitry is configured to execute a client application associated with the host application, thereby providing the user data.
   41. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   42. A method implemented in a communication system including a host computer, a base station and a user equipment (UE), the method comprising:
at the host computer, receiving user data transmitted to the base station from the UE, wherein the UE performs any of the steps of any of the Group A embodiments.
   43. The method of the previous embodiment, further comprising, at the UE, providing the user data to the base station.
   44. The method of the previous 2 embodiments, further comprising:
at the UE, executing a client application, thereby providing the user data to be transmitted; and
at the host computer, executing a host application associated with the client application.
   45. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   46. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   47. The communication system of the previous embodiment further including the base station.
   48. The communication system of the previous 2 embodiments, further including the UE, wherein the UE is configured to communicate with the base station.

49. The communication system of the previous 3 embodiments, wherein:
the processing circuitry of the host computer is configured to execute a host application;
the UE is configured to execute a client application associated with the host application, thereby providing the user data to be received by the host computer.
   50. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   51. The method of the previous embodiment, further comprising at the base station, receiving the user data from the UE.
   52. The method of the previous 2 embodiments, further comprising at the base station, initiating a transmission of the received user data to the host computer.

1. A method performed by a wireless device for reporting failure information in a self-organizing network, SON, the method comprising:
receiving, from a source cell while being connected to the source cell, a handover command to attempt a handover from the source cell to a target cell, one or more bearers associated with the handover from the source cell to the target cell being configured with a dual active protocol stack, DAPS;
experiencing a failure while attempting the handover from the source cell to the target cell;
storing first failure information associated with the failure while attempting the handover from the source cell to the target cell;
performing a DAPS fallback to the source cell based at least in part on experiencing the failure while attempting the handover from the source cell to the target cell;
experiencing a radio link failure, RLF, while being connected to the source cell;
storing second failure information associated with experiencing the RLF; and
transmitting the first failure information or the second failure information towards the SON.

2. The method of claim 1, wherein experiencing the RLF while being connected to the source cell comprises experiencing the RLF while being connected to the source cell after the DAPS fallback.

3. The method of claim 1, further comprising:
deleting the first failure information based at least in part on experiencing the RLF while being connected to the source cell.

4. The method of claim 3, further comprising:
logging that the first failure information was deleted.

5. The method of claim 1, wherein storing the first failure information includes storing the first failure information in a radio link failure, RLF, report or storing the second failure information includes storing the second failure information in the RLF report.

6. The method of claim 1, wherein storing the second failure information includes storing time-since-fallback information indicating a time elapsed between experiencing the failure while attempting the handover from the source cell to the target cell and experiencing the RLF while being connected to the source cell.

7. The method of claim 1, wherein storing the second failure information includes storing time-conn-failure information indicating a time elapsed between receiving the handover command and experiencing the radio link failure while being connected to the source cell.

8. The method of claim 1, wherein storing the second failure information includes storing conn-time-failure information indicating a time elapsed between initiating the handover from the source cell to the target cell and experiencing the radio link failure while being connected to the source cell.

9. The method of claim 1, wherein storing the second failure information includes storing fallback-flag information indicating the experiencing of the RLF after performing the DAPS fallback, wherein the fallback-flag information may be used to determine whether time-conn-failure information or conn-time-failure represents a time elapsed between experiencing the failure while attempting the handover from the source cell to the target cell, based at least in part on which the wireless device performed the DAPS fallback, and experiencing the RLF.

10. The method of claim 1, wherein storing the second failure information includes storing timing information indicating a time elapsed between receiving the handover command and experiencing the failure while attempting the handover from the source cell to the target cell.

11. The method of claim 1, wherein storing the second failure information includes storing fallback timing information indicating a time elapsed between receiving the handover command and performing the DAPS fallback.

12. The method of claim 1, wherein storing the second failure information includes storing radio-measurement information indicating available radio measurements associated with a serving cell, a target cell, or a neighboring cell during a time duration between performing the DAPS fallback and experiencing the RLF while being connected to the source cell.

13. The method of claim 1, wherein storing the second failure information includes storing time-since-last-unsuccessful-HO timing information indicating a time elapsed between receiving the handover command and experiencing the failure while attempting the handover from the source cell to the target cell.

14. The method of claim 1, wherein storing the second failure information includes storing time-to-last-unsuccessful-HO timing information indicating a time elapsed between initiating the handover and experiencing the failure while attempting the handover from the source cell to the target cell.

15. A method performed by a base station in a self-organizing network, the method comprising:
receiving first failure information or second failure information from a wireless device;
determining whether the wireless device experienced a radio link failure, RLF, after performing a dual active protocol stack, DAPS, fallback; and
optimizing a handover configuration including optimizing one or more handover parameters based at least in part on determining the wireless device experienced the RLF after performing the DAPS fallback.

16. The method of claim 15, further comprising:
determining whether the wireless device experienced the RLF before performing the DAPS fallback and within a predetermined time window from completing a handover from a first cell to a source cell; and
optimizing a handover configuration including optimizing one or more handover parameters based at least in part on determining the wireless device experienced the RLF before performing the DAPS fallback and within the predetermined time window from completing the handover from the first cell to the source cell.

17. The method of claim 15, further comprising:
determining identity information of another base station associated with experiencing a failure while attempting a handover based at least in part on the first failure information or with experiencing a RLF based at least in part on the second failure information; and
forwarding the first failure information or the second failure information to the other base station to enable the other base station to optimize a handover configuration including optimizing one or more handover parameters.

18. A wireless device configured to operate in a self-organizing network, SON, the wireless device comprising:
processing circuitry; and
memory coupled with the processing circuitry, wherein the memory includes instructions that when executed by the processing circuitry causes the wireless device to perform operations comprising:
receiving, from a source cell while being connected to the source cell, a source handover command to attempt a handover from the source cell to a target cell, one or more bearers associated with the handover from the source cell to the target cell being configured with a dual active protocol stack (DAPS);
experiencing a failure while attempting the handover from the source cell to the target cell;
storing first failure information associated with the failure while attempting the handover from the source cell to the target cell;
performing a DAPS fallback to the source cell based at least in part on experiencing the failure while attempting the handover from the source cell to the target cell;
experiencing a radio link failure while being connected to the source cell after the DAPS fallback;
storing second failure information associated with experiencing the radio link failure; and
transmitting the first failure information or the second failure information towards the SON.

19. The wireless device of claim 18, wherein experiencing the RLF while being connected to the source cell comprises experiencing the RLF while being connected to the source cell after the DAPS fallback.

20. A base station comprising:
processing circuitry; and
memory coupled with the processing circuitry, wherein the memory includes instructions that when executed by the processing circuitry causes the base station to perform operations comprising:
receiving first failure information or second failure information from a wireless device;
determining whether the wireless device experienced a radio link failure, RLF, after performing a dual active protocol stack, DAPS, fallback; and
optimizing a handover configuration including optimizing one or more handover parameters based at least in part on determining the wireless device experienced the RLF after performing the DAPS fallback.

26. The base station of claim 20, wherein the memory includes further instructions that when executed by the processing circuitry causes the base station to perform further operations comprising:
determining whether the wireless device experienced the RLF before performing the DAPS fallback and within a predetermined time window from completing a handover from a first cell to a source cell; and
optimizing a handover configuration including optimizing one or more handover parameters based at least in part on determining the wireless device experienced the RLF before performing the DAPS fallback and within the predetermined time window from completing the handover from the first cell to the source cell.

27.-30. (canceled)

31. The wireless device of claim 18, wherein the memory includes further instructions that when executed by the processing circuitry causes the wireless device to perform further operations comprising:
deleting the first failure information based at least in part on experiencing the RLF while being connected to the source cell.

32. The wireless device of claim 31, wherein the memory includes further instructions that when executed by the processing circuitry causes the wireless device to perform further operations comprising:
logging that the first failure information was deleted.

33. The wireless device of claim 18, wherein storing the first failure information includes storing the first failure information in a radio link failure, RLF, report or storing the second failure information includes storing the second failure information in the RLF report.

34. The wireless device of claim 18, wherein storing the second failure information includes storing time-since-fallback information indicating a time elapsed between experiencing the failure while attempting the handover from the source cell to the target cell and experiencing the RLF while being connected to the source cell.

35. The base station of claim 20, wherein the memory includes further instructions that when executed by the processing circuitry causes the base station to perform further operations comprising:
determine identity information of another base station associated with experiencing a failure while attempting a handover based at least in part on the first failure information or with experiencing a RLF based at least in part on the second failure information; and
forward the first failure information or the second failure information to the other base station to enable the other base station to optimize a handover configuration including optimizing one or more handover parameters.
